(19) United States
(12) Patent Application Publication
(10) Pub. No.: US 2026/0303175 A1
(43) Pub. Date: Oct. 1, 2026

(54) METHOD AND APPARATUS IN A NODE FOR DATA COLLECTION IN WIRELESS COMMUNICATION

(71) Applicant: Shanghai Codus Technology Company Limited, SHANGHAI (CN)

(72) Inventors: Qi JIANG, SHANGHAI (CN); Lu WU, Shanghai (CN)

(21) Appl. No.: 19/561,574

(22) Filed: Mar. 10, 2026

(30) Foreign Application Priority Data
Mar. 28, 2025 (CN) 202510388613.5

(51) Int. Cl. H04B 7/06; H04B 17/318

(52) U.S. Cl. CPC H04B 7/0626; H04B 17/328

(57) ABSTRACT

This application discloses a data collection in wireless communications. A first node receives a first information block, which indicates a process for a RS resource; the process for the first RS resource set includes performing measurement on the first RS resource; candidates for a process for the first RS resource include for CSI reporting and for data collection; the process for the first RS resource is associated with a first priority value, which depends on a first parameter, and the first parameter depends on whether the process for the first RS resource includes for CSI reporting. This application couples a priority value calculation for data collection with a priority value for CSI reporting, which is conducive to improving resource utilization efficiency, avoiding resource redundancy or waste, and enhancing the overall performance and response speed of the network.

### CROSS REFERENCE TO RELATED APPLICATIONS

This application claims the priority benefit of Chinese Patent Application No. 202510388613.5, filed on Mar. 28, 2025, the full disclosure of which is incorporated herein by reference.

### BACKGROUND

### Technical Field

This application relates to methods and apparatuses for signal transmission in wireless communication systems, and in particular relates to a method and apparatus for prioritization of data collection.

### Related Art

In traditional wireless communications, a User Equipment (UE) reports various auxiliary information obtained through measurements on downlink signals and/or channels, such as channel information, auxiliary information related to Beam Management (BM), positioning-related auxiliary information, Hybrid Automatic Repeat reQuest (HARQ)-ACKnowledgement (ACK) information, beam/radio link failure auxiliary information, etc. The UE reports this information to the network device, which then selects appropriate transmission parameters for the UE based on the report, such as a camping cell, Modulation and Coding Scheme (MCS), Transmitted Precoding Matrix Indicator (TPMI), Transmission Configuration Indication (TCI), and other parameters. In addition, UE reporting can be used to optimize network parameters, such as achieving better cell coverage and turning base stations on/off based on UE locations.

Application scenarios of future wireless communication systems are becoming increasingly diversified. To meet different performance requirements of various scenarios, 3rd Generation Partnership Project (3GPP) launched standard research on Radio Access Network (RAN) intelligence starting from Release-16 (Rel-16), and officially established an AI/ML-based 5G air interface enhancement project in Rel-18, initiating international standardization work on the integration of 5G air interface with AI/ML. This work mainly focuses on use cases, Life Cycle Management (LCM), simulation verification, data collection, and other aspects. The development of AI/ML has entered the large model era; communication large models can realize autonomous networks and intelligent services, support network operation optimization, and improve network efficiency. The deep integration of communication and AI is an important direction for future communication evolution. AI will empower the development and upgrading from 5G and 5.5G to 6G, bringing new management models such as automated frequency band and traffic management, real-time analysis of user data and network load, and network state prediction.

### SUMMARY

In the Rel-18 standards, clear definitions of resource occupation and corresponding priority designs are provided for the processing of physical layer channel information. When the remaining CPU (CSI Processing Unit) resources are insufficient to meet the number of CPUs required for channel processing, the processing of the corresponding channel information will be abandoned. In future networks, a large number of agents will jointly execute complex AI/ML training and inference tasks. Training data collection is a key step for the effective application of AI/ML in wireless communication networks. The impact of measurement and transmission of a large amount of training data on communication systems, and how to reasonably define the priority of processing resources occupied during training data collection are issues that need to be considered.

To address the above issues, this application discloses a solution. It should be noted that although the original intention of this application is for AI/ML scenarios, this application can also be applied to other non-AI/ML scenarios. Furthermore, adopting a unified design scheme for different scenarios (such as other non-AI/ML scenarios including but not limited to Vehicle to Everything (V2X), capacity enhancement systems, short-range communication systems, Non Terrestrial Networks (NTN), Internet of Things (IoT), Ultra Reliable Low Latency Communication (URLLC) networks, etc.) also helps reduce hardware complexity and costs. Where there is no conflict, the embodiments and features in the embodiments of this application can be applied to any other node. Where there is no conflict, the embodiments and features in the embodiments of this application may be arbitrarily combined with each other.

In particular, interpretations of terms, nouns, functions, and variables in this application (unless otherwise specified) can refer to the definitions in 3GPP (3 rd Generation Partnership Project) Technical Specifications (TS), including TS38 series and TS37 series. When necessary, reference may be made to TS38.211, TS38.212, TS38.213, TS38.214, TS38.215, TS38.300, TS38.304, TS38.305, TS38.321, TS38.331, TS37.355, and TS38.423 in the 3GPP technical standards to assist in understanding this application.

In one embodiment, interpretations of the terms in this application refer to the definitions in 3GPP specification TS38 series.

In one embodiment, interpretations of the terms in this application refer to the definitions in 3GPP specification TS37 series.

In one embodiment, interpretations of the terms in this application refer to the definitions in Rel-17 version of 3GPP specification.

In one embodiment, interpretations of the terms in this application refer to the definitions in Rel-18 version of 3GPP specification.

The present application provides a method in a first node for data collection in wireless communications, comprising:
receiving a first information block, wherein the first information block indicates a process for a first RS resource;
wherein the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, problems to be solved by this application include: calculating the priority value associated with a process for an RS resource when the process can be used for CSI reporting and/or data collection.

In one embodiment, problems to be solved by the present application include: how to reduce the impact of data collection services occupying processing resources on CSI reporting services when the UE's processing resources are limited.

In one embodiment, characteristics of the above method include: in this application, the calculation of the priority value for data collection is coupled with the calculation of the priority value for CSI reporting, and then the priority value of a process is determined according to whether the process includes CSI reporting, thereby solving the above problems.

In one embodiment, characteristics of the above method include: the at least for CSI reporting and for data collection includes at least the first two of for CSI reporting, for data collection, and for both CSI reporting and data collection.

In one embodiment, advantages of the above method include: this application supports the deep integration of AI and communication by supporting UE data collection, improves the adaptability and intelligence level of the communication system, and further enhances the performance, efficiency, and user experience of the communication system.

In one embodiment, advantages of the above method include: minimal modifications to existing standards and simple implementation.

In one embodiment, advantages of the above method include: coupling the calculation of the priority value for data collection with the priority value for CSI reporting helps improve resource utilization, avoid resource redundancy or waste, and enhance the overall efficiency and response speed of the network.

In one embodiment, advantages of the above method include: this application supports the scenario where a process for an RS resource is simultaneously used for CSI reporting and data collection, and refines the priority allocation granularity of data collection processes to each data calculation during data collection, providing higher flexibility.

According to one aspect of the present application, the above method is characterized in that: when the process for the first RS resource includes for CSI reporting, the first priority value is equal to a first integer; when the process for the first RS resource does not include CSI reporting, the first priority value is equal to a second integer; the first integer is a non-negative integer, the second integer is a positive integer, and the second integer is greater than the first integer.

In one embodiment, characteristics of the above method include: in this application, the higher the priority value corresponding to a process, the lower the priority of the process; further, the priority of a process including CSI reporting is higher than the priority of a process not including CSI reporting.

In one embodiment, advantages of the above method include: good compatibility.

In one embodiment, advantages of the above method include: prioritizing the UE's processing resources for CSI reporting to ensure the transmission of critical task data and achieve better quality of service.

In one embodiment, advantages of the above method include: this application indirectly increases the priority of resource occupation for data collection by dynamically adjusting CSI reporting scheduling (e.g., reducing aperiodic CSI reporting scheduling when the channel environment is good).

According to one aspect of the present application, the above method is characterized in that: the process for the first RS resource is only for CSI reporting or for data collection; when the process for the first RS resource is for CSI reporting, the first parameter is equal to 0; when the process for the first RS resource is for data collection, the first parameter is not equal to 0.

In one embodiment, problems to be solved by the present application include: how the first node calculates the priority of a process for data collection.

In one embodiment, characteristics of the above method include: in this application, a first parameter is introduced into the CSI reporting priority value calculation formula, and the first parameter is used to determine whether the process for the first RS resource is used for CSI reporting; when the process is used for CSI reporting, the first parameter is 0, which ensures that the priority value of the process for CSI reporting is lower than the priority of the process for data collection.

In one embodiment, characteristics of the above method include: a process for an RS resource in this method cannot be simultaneously used for CSI reporting and data collection.

In one embodiment, characteristics of the above method include: a priority of a process for CSI reporting is higher than a priority of a process for data collection.

In one embodiment, advantages of the above method include: determining the priority value of data collection by enhancing the CSI reporting priority value calculation formula, reducing the impact of data collection on CSI reporting, ensuring that the normal communication services of the UE are not affected, and helping to maintain network stability and performance.

In one embodiment, advantages of the above method include: simple implementation and easy deployment.

According to one aspect of the present application, the above method is characterized in that: the process for the first RS resource is for CSI reporting, for data collection, or for both CSI reporting and data collection; when the process for the first RS resource is for CSI reporting or for both CSI reporting and data collection, the first parameter is equal to 0; when the process for the first RS resource is for data collection, the first parameter is not equal to 0.

In one embodiment, problems to be solved by the present application include: how to determine the priority value of a process when the process for an RS resource can be simultaneously used for CSI reporting and data collection.

In one embodiment, characteristics of the above method include: in this application, when a process for an RS resource can be simultaneously used for CSI reporting and data collection, the priority of the process depends on the priority of the CSI reporting.

In one embodiment, characteristics of the above method include: when the UE performs data collection and CSI reporting, it may need to measure a same RS resource and calculate a same data type (e.g., L1-RSRP, L1-SINR, etc.). In this application, when the above situation occurs, the data collection and CSI reporting processes are allowed to be merged, so that data collection and CSI reporting occupy same processing resources.

In one embodiment, characteristics of the above method include: the process for the RS includes one CSI reporting or one data collection calculation.

In one embodiment, advantages of the above method include: optimizing resource allocation, improving resource utilization, and avoiding resource waste.

In one embodiment, advantages of the above method include: making the priority of a process simultaneously used for CSI reporting and data collection depend on the priority of the CSI reporting reduces the impact of data collection on CSI reporting, ensures that the normal communication services of the UE are not affected, and increases data collection opportunities.

In one embodiment, advantages of the above method include: the result of one calculation can be reused multiple times, reducing computational complexity and avoiding redundant calculations.

According to one aspect of the present application, the above method is characterized in that: the first priority value depends on a second parameter; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

In one embodiment, characteristics of the above method include: when the process for the first RS resource includes for CSI reporting, the second parameter depends on the time-domain behavior of the CSI reporting.

In one embodiment, characteristics of the above method include: when the first parameter in this application is the same, the priority of the process for the first RS resource depends on the second parameter.

In one embodiment, characteristics of the above method include: when the process for the first RS resource is for data collection, this method reinterprets the second parameter. Unlike CSI reporting, data collection has low real-time requirements but high continuity requirements. This method comprehensively considers the differences between CSI reporting and data collection and introduces a priority judgment rule for processes for data collection.

In one embodiment, advantages of the above method include: the new judgment rule can combine the requirements of the physical layer, MAC layer, and application layer to achieve more comprehensive priority management for data collection.

In one embodiment, advantages of the above method include: fully considering the differences between data collection and CSI reporting, and introducing specific priority judgment rules for data collection, resulting in better applicability.

In one embodiment, advantages of the above method include: minimal modifications to existing standards and simple implementation.

According to one aspect of the present application, the above method is characterized in that: when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

In one embodiment, characteristics of the above method include: candidates for the first parameter depend on whether the process for the first RS resource includes for CSI reporting.

In one embodiment, characteristics of the above method include: when the process for the first RS resource is for CSI reporting, the time-domain behavior of the CSI reporting indicates which of 0, 1, 2, and 3 the first parameter takes; when the process for the first RS resource is for data collection, the first parameter is a positive integer not less than 4.

In one embodiment, characteristics of the above method include: this method introduces new candidate values into the parameters for time-domain behavior in the current CSI reporting priority calculation, achieving the effect that the priority of process for CSI reporting is higher than the priority of process for data collection.

In one embodiment, advantages of the above method include: good compatibility.

In one embodiment, advantages of the above method include: minimal modifications to existing standards and simple implementation.

In one embodiment, advantages of the above method include: setting the priority of CSI reporting higher than the priority of data collection reduces the impact of data collection on communication services and ensures that processing resources are prioritized for the normal communication of the UE.

According to one aspect of the present application, the above method is characterized in that: the first priority value depends on a third parameter; when the process for the first RS resource includes for CSI reporting, the third parameter depends on a reporting identifier corresponding to the CSI reporting; when the process for the first RS resource is only for data collection, the third parameter depends on a data set identifier corresponding to the process for the first RS resource.

In one embodiment, characteristics of the above method include: the first priority value depends on both a first parameter and a third parameter, and the third parameter is different from the first parameter.

In one embodiment, characteristics of the above method include: in this method, the third parameter is interpreted differently when the process for the first RS resource is for CSI reporting and for data collection, and the third parameter has different meanings when the process for the first RS resource is for CSI reporting and for data collection.

In one embodiment, characteristics of the above method include: a data set identifier corresponding to the process for the first RS resource is configured by higher-layer signaling.

In one embodiment, advantages of the above method include: reduced computational complexity and easy deployment.

In one embodiment, advantages of the above method include: associating the priority of data collection with the data set identifier of data collection allows the base station to indicate the priority of data collection by indicating the configured identifier.

In one embodiment, advantages of the above method include: higher flexibility and versatility.

According to one aspect of the present application, the above method is characterized in that: the first node is a user equipment.

According to one aspect of the present application, the above method is characterized in that: the first node is a terminal.

The present application provides a method in a second node for data collection in wireless communications, comprising:
transmitting a first information block, wherein the first information block indicates a process for a first RS resource;
wherein the process for the first RS resource set includes a receiver of the first information block measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, characteristics of the above method include: the second node includes a base station and a core network.

In one embodiment, characteristics of the above method include: the second node includes a core network.

In one embodiment, characteristics of the above method include: the second node includes an entity for deploying an AI/ML model.

In one embodiment, characteristics of the above method include: the second node includes a node for deploying an AI/ML model.

In one embodiment, characteristics of the above method include: the second node includes a base station.

In one embodiment, characteristics of the above method include: the second node is a base station.

In one embodiment, characteristics of the above method include: the second node is an LMF.

In one embodiment, characteristics of the above method include: the second node is an OAM.

In one embodiment, characteristics of the above method include: the second node is a gNB.

In one embodiment, characteristics of the above method include: the second node is a network device, and the network device includes at least one of a core network device and an access network device.

In one embodiment, characteristics of the above method include: the second node is a device that provides wireless communication function services, can communicate with terminal devices, and is usually located on the network side.

In one embodiment, characteristics of the above method include: the base station in this application includes a core network.

In one embodiment, characteristics of the above method include: the base station in this application includes a core network device.

In one embodiment, characteristics of the above method include: the base station in this application includes an entity for deploying an AI/ML model.

In one embodiment, characteristics of the above method include: the base station in this application includes a node for deploying an AI/ML model.

According to one aspect of the present application, the above method is characterized in that: when the process for the first RS resource includes for CSI reporting, the first priority value is equal to a first integer; when the process for the first RS resource does not include CSI reporting, the first priority value is equal to a second integer; the first integer is a non-negative integer, the second integer is a positive integer, and the second integer is greater than the first integer.

According to one aspect of the present application, the above method is characterized in that: the process for the first RS resource is only for CSI reporting or for data collection; when the process for the first RS resource is for CSI reporting, the first parameter is equal to 0; when the process for the first RS resource is for data collection, the first parameter is not equal to 0.

According to one aspect of the present application, the above method is characterized in that: the process for the first RS resource is for CSI reporting, for data collection, or for both CSI reporting and data collection; when the process for the first RS resource is for CSI reporting or for both CSI reporting and data collection, the first parameter is equal to 0; when the process for the first RS resource is for data collection, the first parameter is not equal to 0.

According to one aspect of the present application, the above method is characterized in that: the first priority value depends on a second parameter; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

According to one aspect of the present application, the above method is characterized in that: when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

According to one aspect of the present application, the above method is characterized in that: the first priority value depends on a third parameter; when the process for the first RS resource includes for CSI reporting, the third parameter depends on a reporting identifier corresponding to the CSI reporting; when the process for the first RS resource is only for data collection, the third parameter depends on a data set identifier corresponding to the process for the first RS resource.

According to one aspect of the present application, the above method is characterized in that: the second node is a base station.

The present application provides a first node for data collection in wireless communications, comprising:
a first receiver configured to receive a first information block, wherein the first information block indicates a process for a first RS resource;
wherein the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

The present application provides a second node for data collection in wireless communications, comprising:
a first transmitter configured to transmit a first information block, wherein the first information block indicates a process for a first RS resource;
wherein the process for the first RS resource set includes a receiver of the first information block measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, compared with traditional solutions, this application has the following advantageous but non-limiting advantages:

The present application supports the deep integration of AI and communication by supporting UE data collection, improves the adaptability and intelligence level of the communication system, and further enhances the performance, efficiency, and user experience of the communication system;

The present application supports the scenario where a process for an RS resource is simultaneously used for CSI reporting and data collection, and refines the priority allocation granularity of data collection processes to each data calculation during data collection, providing higher flexibility;

It reduces the impact of data collection on CSI reporting, ensures that the normal communication services of the UE are not affected, and helps maintain network stability and performance;

It requires minimal modifications to existing standards and is simple to implement.

### BRIEF DESCRIPTION OF THE DRAWINGS

By reading the detailed description of non-limiting embodiments with reference to the following drawings, other features, objects, and advantages of this application will become more apparent:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of an embodiment of a radio protocol architecture for a user plane and a control plane according to one embodiment of the present application;

FIG. 4 illustrates a schematic diagram of a first communication device and a second communication device according to one embodiment of the present application;

FIG. 5 illustrates a flowchart of transmission between a first node and a second node according to one embodiment of the present application;

FIG. 6 illustrates a schematic diagram of the relationship between priority and priority value according to one embodiment of the present application;

FIG. 7 illustrates a first schematic diagram of two cases of a first parameter according to one embodiment of the present application;

FIG. 8 illustrates a second schematic diagram of two cases of a first parameter according to one embodiment of the present application;

FIG. 9 illustrates a schematic diagram of two cases of a second parameter according to one embodiment of the present application;

FIG. 10 illustrates a third schematic diagram of two cases of a first parameter according to one embodiment of the present application;

FIG. 11 illustrates a schematic diagram of a third parameter according to one embodiment of the present application;

FIG. 12 illustrates a schematic diagram of RAN domain AI/ML function deployment according to one embodiment of the present application;

FIG. 13 illustrates a schematic diagram of UE AI/ML function deployment according to one embodiment of the present application;

FIG. 14 illustrates a schematic diagram of a processing system based on artificial intelligence (AI) or machine learning (ML) according to one embodiment of the present application;

FIG. 15 illustrates a schematic diagram of AI or ML according to one embodiment of the present application;

FIG. 16 illustrates a structural block diagram of a processor in a first node according to one embodiment of the present application;

FIG. 17 illustrates a structural block diagram of a processor in a second node according to one embodiment of the present application.

### DESCRIPTION OF THE EMBODIMENTS

The technical solutions of this application will be described in further detail below with reference to the accompanying drawings. It should be noted that, where there is no conflict, the embodiments and features in the embodiments of this application may be arbitrarily combined with each other. Based on considerations of performance, flexibility, complexity, overhead, compatibility, etc., those skilled in the art are motivated to flexibly combine the embodiments in different drawings without contradiction, including but not limited to the embodiment in FIG. 1 and the embodiments in FIGS. 5-17, the embodiment in FIG. 5 and the embodiments in FIGS. 6-17, etc.

### Embodiment 1

Embodiment 1 illustrates a flowchart of transmission of a first node according to one embodiment of the present application, as shown in FIG. 1. In FIG. 1, each block represents a step. In particular, the order of steps in the blocks does not represent a specific time sequence relationship between the steps.

The first node receives a first information block in step 101, wherein the first information block indicates a process for a first RS resource.

In Embodiment 1, the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, the first node is a user equipment (UE).

In one embodiment, the first node is a terminal.

In one embodiment, the first node in this application includes a core network device that provides services for terminal AI.

In one embodiment, the first node in this application includes an application layer device that provides services for terminal AI.

In one embodiment, the first node in this application includes an Agent that provides services for terminal AI.

In one embodiment, the first node in this application includes a Handset (mobile phone).

In one embodiment, the first node is the first node in this application.

In one embodiment, the RS refers to: Reference Signal.

In one embodiment, the first node receives the first information block.

In one embodiment, the first information block is UE dedicated.

In one embodiment, the first information block is cell common.

In one embodiment, the first information block is cell-group common.

In one embodiment, the first information block is carried by higher layer signaling.

In one embodiment, the first information block is transmitted through Radio Resource Control (RRC) signaling.

In one embodiment, the first information block includes one or more RRC Information Elements (IEs).

In one embodiment, the first information block includes one or more fields in one RRC IE.

In one embodiment, the first information block includes information in one or more fields of each of multiple RRC IEs.

In one embodiment, the first information block is an RRC IE.

In one embodiment, the first information block includes a ServingCellConfig IE.

In one embodiment, the first information block includes one or more fields in a ServingCellConfig IE.

In one embodiment, the first information block includes a CSI-MeasConfig IE.

In one embodiment, the first information block includes one or more fields in a CSI-MeasConfig IE.

In one embodiment, the first information block includes an NZP-CSI-RS-Resource IE.

In one embodiment, the first information block includes one or more fields in an NZP-CSI-RS-Resource IE.

In one embodiment, the first information block includes an NZP-CSI-RS-ResourceSet IE.

In one embodiment, the first information block includes one or more fields in an NZP-CSI-RS-ResourceSet IE.

In one embodiment, the first information block includes a CSI-IM-Resource IE.

In one embodiment, the first information block includes one or more fields in a CSI-IM-Resource IE.

In one embodiment, the first information block includes a CSI-IM-ResourceSet IE.

In one embodiment, the first information block includes one or more fields in a CSI-IM-ResourceSet IE.

In one embodiment, the first information block includes a CSI-SSB-ResourceSet IE.

In one embodiment, the first information block includes one or more fields in a CSI-SSB-ResourceSet IE.

In one embodiment, the first information block includes a CSI-ResourceConfig IE.

In one embodiment, the first information block includes one or more fields in a CSI-ResourceConfig IE.

In one embodiment, the first information block includes a MeasConfig IE.

In one embodiment, the first information block includes one or more fields in a MeasConfig IE.

In one embodiment, the first information block includes a MeasObjectToAddModList IE.

In one embodiment, the first information block includes one or more fields in a MeasObjectToAddModList IE.

In one embodiment, the first information block includes one or more fields in a MeasObject IE.

In one embodiment, the first information block includes a MeasObjectNR IE.

In one embodiment, the first information block includes a MeasObject6G IE.

In one embodiment, the first information block includes a MeasObject6G IE.

In one embodiment, the first information block includes a CSI-RS-ResourceConfigMobility IE.

In one embodiment, the first information block includes one or more fields in a CSI-RS-ResourceConfigMobility IE.

In one embodiment, the first information block is carried by dynamic signaling.

In one embodiment, the first information block is carried by control signaling.

In one embodiment, the first information block is a control signaling.

In one embodiment, the first information block is carried by Medium Access Control (MAC) layer signaling.

In one embodiment, the first information block is carried by MAC layer control signaling.

In one embodiment, the first information block is carried by MAC Control Element (CE) signaling.

In one embodiment, the first information block is a MAC CE.

In one embodiment, the first information block is carried by an activation command.

In one embodiment, the first information block is carried by an SP CSI-RS/CSI-IM Resource Set Activation/Deactivation MAC CE.

In one embodiment, the first information block is carried by an SP ZP CSI-RS Resource Set Activation/Deactivation MAC CE.

In one embodiment, the first information block is jointly carried by RRC signaling and MAC signaling.

In one embodiment, a name of a signaling used to transmit the first information block includes CSI.

In one embodiment, a name of a signaling used to transmit the first information block includes CSI-RS.

In one embodiment, a name of a signaling used to transmit the first information block includes Config.

In one embodiment, a name of a signaling used to transmit the first information block includes Meas.

In one embodiment, a name of a signaling used to transmit the first information block includes Measurement.

In one embodiment, a name of a signaling used to transmit the first information block includes Object.

In one embodiment, a name of a signaling used to transmit the first information block includes Data.

In one embodiment, a name of a signaling used to transmit the first information block includes DataSet.

In one embodiment, a name of a signaling used to transmit the first information block includes Collection.

In one embodiment, a name of a signaling used to transmit the first information block includes Collect.

In one embodiment, a name of a signaling used to transmit the first information block includes Training.

In one embodiment, a name of a signaling used to transmit the first information block includes Activation.

In one embodiment, a name of a signaling used to transmit the first information block includes Deactivation.

In one embodiment, a name of a signaling used to transmit the first information block includes Resource.

In one embodiment, a name of a signaling used to transmit the first information block includes AI.

In one embodiment, a name of a signaling used to transmit the first information block includes ML.

In one embodiment, the first RS resource is periodic.

In one embodiment, the first RS resource is a periodic RS resource.

In one embodiment, the first RS resource is Semi-Persistent (SP).

In one embodiment, the first RS resource is an SP RS resource.

In one embodiment, the first RS resource is a downlink RS resource.

In one embodiment, the first RS resource is an RS resource for time-frequency resource tracking.

In one embodiment, the first RS resource is a Phase-Tracking Reference Signal (PTRS) resource.

In one embodiment, the first RS resource is an RS resource for positioning.

In one embodiment, the first RS resource is a Positioning Reference Signal (PRS) resource.

In one embodiment, the first RS resource is an RS resource for channel estimation.

In one embodiment, the first RS resource is an RS resource for demodulation.

In one embodiment, the first RS resource is a DeModulation Reference Signal (DMRS) resource.

In one embodiment, the first RS resource is an RS resource for sensing.

In one embodiment, the first RS resource is an RS resource for Integrated Sensing And Communication (ISAC).

In one embodiment, the first RS resource is an ISAC-RS resource.

In one embodiment, the first RS resource is an ISAC Reference Signal (IRS) resource.

In one embodiment, the first RS resource is an RS resource for Mobility management.

In one embodiment, the first RS resource is an RS resource for cell-level mobility management.

In one embodiment, the first RS resource is an RS resource for Beam-level mobility management.

In one embodiment, the first RS resource includes an RS resource for synchronization.

In one embodiment, the first RS resource includes synchronization signals in at least 5G systems and post-5G systems.

In one embodiment, the first RS resource includes synchronization signals in at least 6G systems.

In one embodiment, the first RS resource includes at least a Synchronization Signal (SS).

In one embodiment, the first RS resource includes at least a Primary Synchronization Signal (PSS).

In one embodiment, the first RS resource includes at least a Secondary Synchronization Signal (SSS).

In one embodiment, the first RS resource includes at least a Physical Broadcast CHannel (PBCH).

Typically, the reception occasions of the PBCH, the PSS, and the SSS are in consecutive symbols and form an SS/PBCH block.

In one embodiment, the first RS resource is a CSI-RS resource or an SSB resource.

In one embodiment, the first RS resource is identified by an NZP-CSI-RS-ResourceId or an SSB-Index

In one embodiment, the first RS resource belongs to a CSI-RS resource set.

In one embodiment, the first RS resource belongs to an NZP CSI-RS resource set.

In one embodiment, the first RS resource is a CSI-RS resource.

In one embodiment, the first RS resource is identified by a CSI-ResourceConfigId.

In one embodiment, the first RS resource is a Non-Zero-Power (NZP) CSI-RS resource.

In one embodiment, the first RS resource belongs to a CSI-SSB resource set.

In one embodiment, the first RS resource is an SSB.

In one embodiment, the first RS resource is an SSB resource.

In one embodiment, the first RS resource is identified by an SSB-Index.

In one embodiment, the SSB in this application refers to: Synchronization Signal Block.

In one embodiment, the SSB in this application refers to: SS/PBCH block.

In one embodiment, the first information block indicates the first RS resource.

In one embodiment, the first information block configures the first RS resource.

In one embodiment, the first information block indicates an identifier of the first RS resource.

In one embodiment, an identifier of the first RS resource is an NZP-CSI-RS-ResourceId or an SSB-Index.

In one embodiment, an identifier of the first RS resource is a CSI-ResourceConfigId.

In one embodiment, an identifier of the first RS resource is an NZP-CSI-RS-ResourceId.

In one embodiment, an identifier of the first RS resource is an SSB-Index.

In one embodiment, the first information block indicates an RS resource set to which the first RS resource belongs.

In one embodiment, the first information block configures an RS resource set to which the first RS resource belongs.

In one embodiment, the first information block indicates an identifier of the RS resource set to which the first RS resource belongs.

In one embodiment, an identifier of an RS resource set to which the first RS resource belongs is an NZP-CSI-RS-ResourceSetId.

In one embodiment, an identifier of an RS resource set to which the first RS resource belongs is a CSI-SSB-ResourceSetId.

In one embodiment, an identifier of an RS resource set to which the first RS resource belongs is an NZP-CSI-RS-ResourceSetId or a CSI-SSB-ResourceSetId.

In one embodiment, the first information block configures the process for the first RS resource.

In one embodiment, the first information block indicates the process for the first RS resource.

In one embodiment, the first information block indicates activating the process for the first RS resource.

In one embodiment, the first information block configures activating the process for the first RS resource.

In one embodiment, the first information block indicates the first node to start executing the process for the first RS resource.

In one embodiment, the first information block configures the first node to start executing the process for the first RS resource.

In one embodiment, the process for the first RS resource set includes measuring on the first RS resource.

In one embodiment, the measuring on the first RS resource includes: measuring an RS transmitted on the first RS resource.

In one embodiment, the measuring on the first RS resource includes: performing measurements on an RS transmitted on the first RS resource.

In one embodiment, the measuring on the first RS resource includes: performing measurements on part of RS transmitted on the first RS resource.

In one embodiment, the measuring on the first RS resource includes: performing measurements on one RS transmitted on the first RS resource.

In one embodiment, the measuring on the first RS resource includes: performing measurements on one CSI transmission occasion of the first RS resource.

In one embodiment, the measuring on the first RS resource includes: performing measurements on multiple CSI transmission occasions of the first RS resource.

In one embodiment, the measuring on the first RS resource includes: performing measurements over multiple periods of the first RS resource.

In one embodiment, the process for the first RS resource set includes: measuring on the first RS resource and obtaining at least one piece of channel information.

In one embodiment, the process for the first RS resource set includes: measuring on the first RS resource and obtaining at least one piece of data.

In one embodiment, the process for the first RS resource set includes: storing measurement results obtained from measurements on the first RS resource.

In one embodiment, the process for the first RS resource set includes: storing measurement information obtained from measurements on the first RS resource.

In one embodiment, the process for the first RS resource set includes: partially storing measurement results obtained from measurements on the first RS resource.

In one embodiment, the process for the first RS resource set includes: partially storing measurement information obtained from measurements on the first RS resource.

In one embodiment, the process for the first RS resource set includes: generating a first data set, wherein the first data set is associated with the first RS resource.

In one embodiment, the process for the first RS resource set includes: transmitting measurement results obtained from measurements on the first RS resource.

In one sub-embodiment of the embodiment, the transmitting includes the physical layer transmitting to the higher layer of the first node.

In one sub-embodiment of the embodiment, the transmitting includes the first node transmitting to the second node in this application.

In one embodiment, the measurements include: Intra-frequency measurements.

In one embodiment, the measurements include: Inter-frequency measurements.

In one embodiment, the measurements include: Inter-Radio Access Technology (RAT) measurements.

In one embodiment, the measurements include: Intra-RAT measurements.

In one embodiment, the measurements include: channel measurements.

In one embodiment, the measurements include: received power measurements.

In one embodiment, the measurements include: Reference Signal Received Power (RSRP) measurements.

In one embodiment, the measurements include: Path Loss (PL) measurements.

In one embodiment, the measurements include: channel matrix measurements.

In one embodiment, the measurements include: raw channel matrix measurements.

In one embodiment, the measurements include: eigenvector and eigenvalue measurements.

In one embodiment, the measurements include: BLock Error Rate (BLER) measurements.

In one embodiment, the measurements include: Bit Error Rate (BER) measurements.

In one embodiment, the measurements include: delay spread measurements.

In one embodiment, the measurements include: Doppler shift measurements.

In one embodiment, the measurements include: Doppler spread measurements.

In one embodiment, the measurements include: average delay measurements.

In one embodiment, the measurements include: average gain measurements.

In one embodiment, the measurements include: interference measurements.

In one embodiment, the measurements include: interference channel matrix measurements.

In one embodiment, the measurements include: interference covariance matrix measurements.

In one embodiment, the measurements include: interference eigenvector measurements.

In one embodiment, the measurements include: interference eigenvalue measurements.

In one embodiment, the measurements include: interference beam measurements.

In one embodiment, the measurements include: interference power measurements.

In one embodiment, the measurements include: interference variance measurements.

In one embodiment, the measurements include: interference power spectral density measurements.

In one embodiment, candidates for a process for the first RS resource include at least for CSI reporting and for data collection.

In one embodiment, candidates for the process for the first RS resource include only for CSI reporting and only for data collection.

In one embodiment, candidates for the process for the first RS resource include all three of only for CSI reporting, only for data collection, and for both CSI reporting and data collection.

In one embodiment, the process for the first RS resource being for CSI reporting means that the first RS resource is associated with a CSI report, and the process for the first RS resource includes obtaining the CSI report through measurements.

In one embodiment, the process for the first RS resource being for CSI reporting means that the process for the first RS resource is for aperiodic CSI reporting.

In one embodiment, the process for the first RS resource being for CSI reporting means that the process for the first RS resource is for periodic CSI reporting.

In one embodiment, the process for the first RS resource being for CSI reporting means that the process for the first RS resource is for semi-persistent CSI reporting.

In one embodiment, the process for the first RS resource being for CSI reporting means that the process for the first RS resource is for periodic CSI reporting or semi-persistent CSI reporting.

In one embodiment, the process for the first RS resource being for CSI reporting means that the process for the first RS resource is for one CSI report in periodic CSI reporting or semi-persistent CSI reporting.

In one embodiment, the process for the first RS resource being for data collection means that the process for the first RS resource is for periodic data collection.

In one embodiment, the process for the first RS resource being for data collection means that the process for the first RS resource is for semi-persistent data collection.

In one embodiment, the process for the first RS resource being for data collection means that the process for the first RS resource is for periodic data collection or semi-persistent data collection.

In one embodiment, the process for the first RS resource being for data collection means that the process for the first RS resource is for one data collection in periodic data collection or semi-persistent data collection.

In one embodiment, the process for the first RS resource being for both CSI reporting and data collection means that the process for the first RS resource is for aperiodic CSI reporting, and the process for the first RS resource is for one data collection in periodic data collection or semi-persistent data collection.

In one embodiment, the process for the first RS resource being for both CSI reporting and data collection means that the process for the first RS resource is for one CSI report in periodic CSI reporting or semi-persistent CSI reporting, and the process for the first RS resource is for one data collection in periodic data collection or semi-persistent data collection.

In one embodiment, the process for the first RS resource being for both CSI reporting and data collection means that the process for the first RS resource is for periodic CSI reporting, and the process for the first RS resource is for periodic data collection.

In one embodiment, the process for the first RS resource being for both CSI reporting and data collection means that the process for the first RS resource is for periodic CSI reporting, and the process for the first RS resource is for semi-persistent data collection.

In one embodiment, the process for the first RS resource being for both CSI reporting and data collection means that the process for the first RS resource is for semi-persistent CSI reporting, and the process for the first RS resource is for semi-persistent data collection.

In one embodiment, the process for the first RS resource is associated with a first priority value.

In one embodiment, when the process for the first RS resource is for CSI reporting, the CSI report is associated with a first priority value.

In one embodiment, the process for the first RS resource is for data collection, the data collection is associated with a first priority value.

In one embodiment, the first priority value is a non-negative integer.

In one embodiment, candidates for the first priority value include 0.

In one embodiment, the first priority value depends on the first parameter.

In one embodiment, the first priority value depends on a value of the first parameter.

In one embodiment, the calculation of the first priority value depends on the first parameter.

In one embodiment, the first priority value changes with the change of the first parameter.

In one embodiment, the first priority value is linearly related to the first parameter.

In one embodiment, the first priority value is obtained through calculation by a first function, and the independent variable of the first function includes the first parameter.

In one sub-embodiment of the embodiment, the independent variable of the first function includes the third parameter in this application.

In one sub-embodiment of the embodiment, the independent variable of the first function includes the second parameter and the third parameter in this application.

In one embodiment, the first priority value depends on at least one parameter other than the first parameter.

In one embodiment, the first parameter depends on whether the process for the first RS resource includes for CSI reporting.

In one embodiment, candidates for the first parameter depend on whether the process for the first RS resource includes for CSI reporting.

In one embodiment, a value of the first parameter depends on whether the process for the first RS resource includes for CSI reporting.

In one embodiment, the first parameter depends on whether the process for the first RS resource includes only for data collection.

In one embodiment, a value of the first parameter depends on whether the process for the first RS resource includes only for data collection.

In one embodiment, candidates for the first parameter depend on whether the process for the first RS resource includes only for data collection.

### Embodiment 2

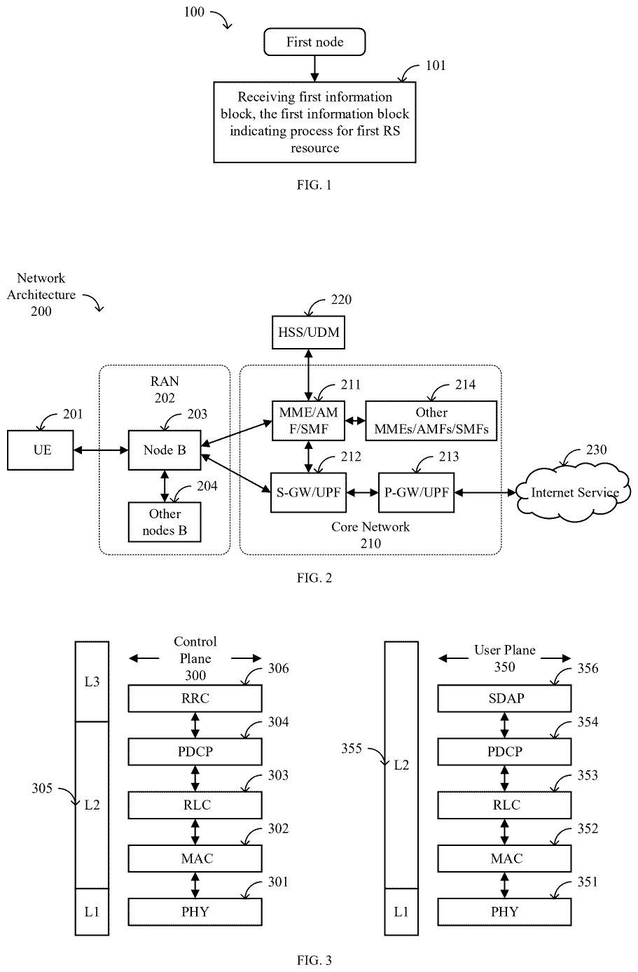

Embodiment 2 illustrates a schematic diagram of a network architecture according to one embodiment of the present application, as shown in FIG. 2.

FIG. 2 illustrates a network architecture 200. The network architecture 200 is that of Long-Term Evolution (LTE), Long-Term Evolution Advanced (LTE-A), 5G systems, 5G-Advanced, and future 6G systems. The network architectures of LTE, LTE-A, 5G systems, 5G-Advanced, and future 6G systems are referred to as Evolved Packet System (EPS). A 5G NR or LTE network architecture may be referred to as 5G System (5GS)/EPS or some other appropriate terminology; a 6G network architecture may be referred to as 6G System (6GS)/EPS or some other appropriate terminology.

The network architecture 200 may include one or more User Equipments (UEs) 201, a Radio Access Network (RAN) 202, a core network 210, a Home Subscriber Server (HSS)/Unified Data Management (UDM) 220, and Internet services 230. The network architecture 200 may be interconnected with other access networks, but these entities/interfaces are not shown for simplicity.

As shown in FIG. 2, the network architecture 200 provides packet switching services; however, those skilled in the art will readily understand that the various concepts presented throughout this application may be extended to networks providing circuit switching services or other cellular networks. The RAN 202 includes a Node B 203 and other nodes 204. The Node B 203 provides user and control plane protocol termination towards the UE 201. The Node B 203 may be connected to other nodes 204 via an Xn interface (e.g., backhaul). The Node B 203 may also be referred to as an evolved Node B (eNB), gNB, base station, base transceiver station, wireless base station, wireless transceiver, transceiver function, Basic Service Set (BSS), Extended Service Set (ESS), Transmitter Receiver Point (TRP), or some other appropriate terminology. The Node B 203 provides an access point to the core network 210 for the UE 201; the core network 210 is a 5G Core network (5GC)/Evolved Packet Core (EPC), or alternatively, the core network 210 is a 6G Core network (6GC). Examples of the UE 201 include cellular phones, smartphones, Session Initiation Protocol (SIP) phones, laptop computers, Personal Digital Assistants (PDAs), satellite radios, Global Positioning System (GPS) devices, multimedia devices, video devices, digital audio players (e.g., MP3 players), cameras, game consoles, unmanned aerial vehicles (UAVs), aircraft, narrowband Internet of Things (IoT) devices, Machine-Type Communication (MTC) devices, land vehicles, automobiles, wearable devices, or any other similar functional devices. Those skilled in the art may also refer to the UE 201 as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other appropriate terminology. The Node B 203 is connected to the core network 210 via an S1/NG interface. The core network 210 includes a Mobility Management Entity (MME)/Authentication Management Field (AMF)/Session Management Function (SMF) 211, other MME/AMF/SMFs 214, a Service Gateway (S-GW)/User Plane Function (UPF) 212, and a Packet Data Network Gateway (P-GW)/UPF 213. The MME/AMF/SMF 211 is a control node that processes signaling between the UE 201 and the core network 210. Generally, the MME/AMF/SMF 211 provides bearer and connection management. All user Internet Protocol (IP) packets are transmitted through the S-GW/UPF 212, which itself is connected to the P-GW/UPF 213. The P-GW provides UE IP address assignment and other functions. The P-GW/UPF 213 is connected to the Internet services 230. The Internet services 230 include operator-corresponding Internet Protocol services, which may specifically include the Internet, intranets, IP Multimedia Subsystem (IMS), and packet-switched streaming services.

In one embodiment, the first node in this application includes the UE 201.

In one embodiment, the second node in this application includes the Node B 203.

In one embodiment, the Node B 203 is a macro cell base station.

In one embodiment, the Node B 203 is a micro cell base station.

In one embodiment, the Node B 203 is a pico cell base station.

In one embodiment, the Node B 203 is a femtocell.

In one embodiment, the Node B 203 is a base station device supporting large time delay differences.

In one embodiment, the Node B 203 is a flight platform device.

In one embodiment, the Node B 203 is a satellite device.

In one embodiment, the Node B 203 is a test device (e.g., a transceiver simulating partial functions of a base station, a signaling tester).

In one embodiment, the UE 201 includes a mobile phone.

In one embodiment, the UE 201 includes a vehicle such as an automobile.

In one embodiment, a wireless link from the UE 201 to the Node B 203 is an uplink, which is used to perform uplink transmission.

In one embodiment, a wireless link from the Node B 203 to the UE 201 is a downlink, which is used to perform downlink transmission.

In one embodiment, a wireless link between the Node B 203 and the UE 201 includes a cellular network link.

In one embodiment, the Node B 203 and the UE 201 are connected via a Uu air interface.

In one embodiment, a transmitter of the first information block in this application includes the Node B 203.

In one embodiment, a receiver of the first information block in this application includes the UE 201.

In one embodiment, the Node B 203 supports the deployment of Network-side (NW-side) AI/ML models.

In one embodiment, the UE 201 supports the deployment of UE-side AI/ML models.

In one embodiment, the UE 201 supports UE-side data collection.

In one embodiment, the UE 201 supports 5G systems.

In one embodiment, the Node B 203 supports 5G systems.

In one embodiment, the UE 201 supports at least 6G systems.

In one embodiment, the Node B 203 supports at least 6G systems.

### Embodiment 3

Embodiment 3 illustrates a schematic diagram of an embodiment of a radio protocol architecture for the user plane and control plane according to one embodiment of the present application, as shown in FIG. 3.

FIG. 3 is a schematic diagram illustrating an embodiment of a radio protocol architecture for a user plane 350 and a control plane 300. FIG. 3 shows the radio protocol architecture for the control plane 300 between a first communication node device (a UE, or a Road Side Unit (RSU) in Vehicle to Everything (V2X), an on-board device, or an on-board communication module) and a second node device (a gNB, UE, or RSU in V2X, an on-board device, or an on-board communication module), or between two UEs, using three layers: Layer 1 (L1), Layer 2 (L2), and Layer 3 (L3). L1 is the lowest layer and implements various PHYsical layer (PHY) signal processing functions. L1 is referred to herein as PHY 301. L2 305 is above PHY 301 and is responsible for the link between the first node device and the second node device, or between two UEs, via PHY 301. L2 305 includes a Medium Access Control (MAC) sublayer 302, a Radio Link Control (RLC) sublayer 303, and a Packet Data Convergence Protocol (PDCP) sublayer 304, which terminate at the second node device. The PDCP sublayer 304 provides multiplexing between different radio bearers and logical channels. The PDCP sublayer 304 also provides security by encrypting data packets and provides handover support for the first communication node device between second communication node devices. The RLC sublayer 303 provides segmentation and reassembly of upper-layer data packets, retransmission of lost data packets, and reordering of data packets to compensate for out-of-order reception due to Hybrid Automatic Repeat reQuest (HARQ). The MAC sublayer 302 provides multiplexing between logical and transport channels. The MAC sublayer 302 is also responsible for allocating various radio resources (e.g., resource blocks) in a cell among first communication node devices. The MAC sublayer 302 is also responsible for HARQ operations. The Radio Resource Control (RRC) sublayer 306 in L3 of the control plane 300 is responsible for acquiring radio resources (i.e., radio bearers) and configuring lower layers using RRC signaling between the second communication node device and the first communication node device. The radio protocol architecture of the user plane 350 includes Layer 1 (L1) and Layer 2 (L2). The radio protocol architecture for the first communication node device and the second communication node device in the user plane 350 is substantially the same as the corresponding layers and sublayers in the control plane 300 for the physical layer 351, the PDCP sublayer 354 in L2 355, the RLC sublayer 353 in L2 355, and the MAC sublayer 352 in L2 355, except that the PDCP sublayer 354 also provides header compression for upper-layer data packets to reduce radio transmission overhead. The L2 355 in the user plane 350 also includes a Service Data Adaptation Protocol (SDAP) sublayer 356, which is responsible for mapping between Quality of Service (QoS) flows and Data Radio Bearers (DRBs) to support service diversity. Although not shown, the first communication node device may have several upper layers above L2 355, including a network layer (e.g., IP layer) terminating at the P-GW on the network side and an application layer terminating at the other end of the connection (e.g., a remote UE, a server, etc.).

In one embodiment, the radio protocol architecture in FIG. 3 is applicable to the first node in this application.

In one embodiment, the radio protocol architecture in FIG. 3 is applicable to the second node in this application.

In one embodiment, the first information block in this application is generated in the RRC 306.

In one embodiment, the first information block in this application is generated in the MAC 302 or the MAC 352.

In one embodiment, the higher layer in this application refers to a layer above the physical layer.

In one embodiment, the higher layer in this application includes the RRC layer.

In one embodiment, the higher-layer signaling in this application includes RRC Information Element (IE).

In one embodiment, the higher-layer signaling in this application includes RRC message.

In one embodiment, the higher layer in this application includes MAC layer.

In one embodiment, the higher-layer signaling in this application includes MAC Control Element (CE).

### Embodiment 4

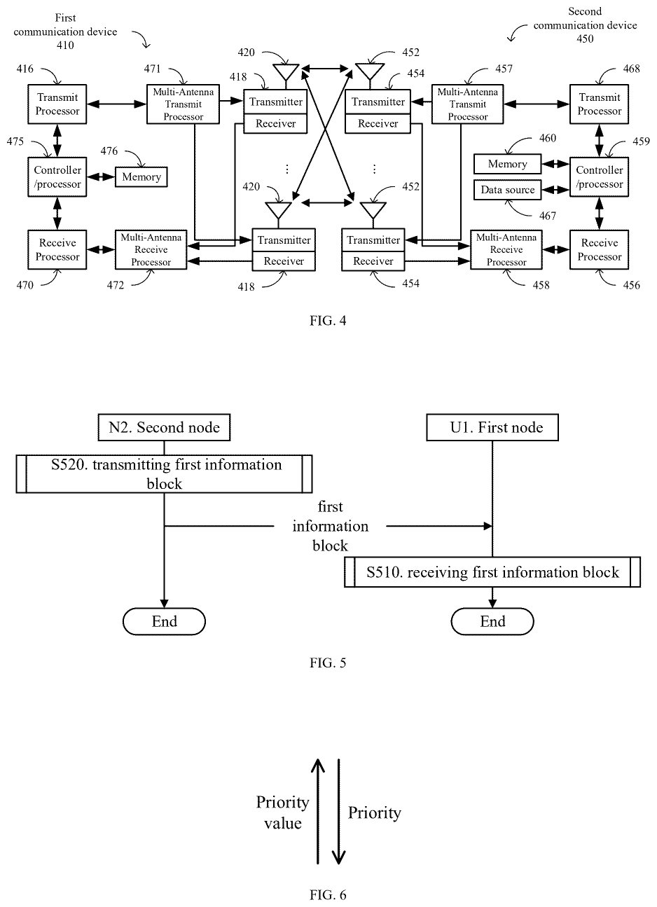

Embodiment 4 illustrates a schematic diagram of a first communication device and a second communication device according to one embodiment of the present application, as shown in FIG. 4. FIG. 4 is a block diagram of a first communication device 410 and a second communication device 450 communicating with each other in an access network.

The first communication device 410 includes a controller/processor 475, a memory 476, a receive processor 470, a transmit processor 416, a multi-antenna transmit processor 471, a multi-antenna receive processor 472, a transmitter/receiver 418, and an antenna 420.

The second communication device 450 includes a controller/processor 459, a memory 460, a data source 467, a transmit processor 468, a receive processor 456, a multi-antenna transmit processor 457, a multi-antenna receive processor 458, a transmitter/receiver 454, and an antenna 452.

In transmission from the first communication device 410 to the second communication device 450, at the first communication device 410, upper-layer data packets from the core network are provided to the controller/processor 475. The controller/processor 475 implements L2 functionalities. In the downlink (DL), the controller/processor 475 provides header compression, encryption, packet segmentation and reordering, multiplexing between logical and transport channels, and radio resource allocation to the second communication device 450 based on various priority metrics. The controller/processor 475 is also responsible for HARQ operations, retransmission of lost packets, and signaling to the second communication device 450. The transmit processor 416 and the multi-antenna transmit processor 471 implement various signal processing functions for L1 (i.e., the physical layer). The transmit processor 416 implements coding and interleaving to facilitate Forward Error Correction (FEC) at the second communication device 450, and mapping of signal constellations based on various modulation schemes (e.g., Binary Phase Shift Keying (BPSK), Quadrature Phase Shift Keying (QPSK), M-ary Phase Shift Keying (M-PSK), M-ary Quadrature Amplitude Modulation (M-QAM)). The multi-antenna transmit processor 471 performs digital spatial precoding on the encoded and modulated symbols, including codebook-based precoding, non-codebook-based precoding, and beamforming processing, to generate one or more parallel streams. The transmit processor 416 then maps each parallel stream to subcarriers, multiplexes the modulated symbols with reference signals (e.g., pilots) in time domain and/or frequency domain, and subsequently uses Inverse Fast Fourier Transform (IFFT) to generate a physical channel carrying a time-domain multi-carrier symbol stream. The multi-antenna transmit processor 471 then performs transmit analog precoding/beamforming operations on the time-domain multi-carrier symbol stream. Each transmitter 418 converts the baseband multi-carrier symbol stream provided by the multi-antenna transmit processor 471 into a radio frequency (RF) stream, which is then provided to different antennas 420.

In transmission from the first communication device 410 to the second communication device 450, at the second communication device 450, each receiver 454 receives signals through its corresponding antenna 452. Each receiver 454 recovers information modulated onto the RF carrier and converts the RF stream into a baseband multi-carrier symbol stream, which is provided to the receive processor 456. The receive processor 456 and the multi-antenna receive processor 458 implement various signal processing functions for L1. The multi-antenna receive processor 458 performs receive analog precoding/beamforming operations on the baseband multi-carrier symbol stream from the receiver 454. The receive processor 456 uses Fast Fourier Transform (FFT) to convert the baseband multi-carrier symbol stream after receive analog precoding/beamforming operations from time domain to frequency domain. In frequency domain, physical layer data signals and reference signals are demultiplexed by the receive processor 456, where the reference signals are used for channel estimation, and the data signals are processed through multi-antenna detection in the multi-antenna receive processor 458 to recover any parallel streams destined for the second communication device 450. Symbols on each parallel stream are demodulated and recovered in the receive processor 456 to generate soft decisions. The receive processor 456 then decodes and deinterleaves the soft decisions to recover upper-layer data and control signals transmitted by the first communication device 410 on the physical channel. The upper-layer data and control signals are then provided to the controller/processor 459. The controller/processor 459 implements L2 functions. The controller/processor 459 may be associated with a memory 460 that stores program codes and data. The memory 460 may be referred to as a computer-readable medium. In the DL, the controller/processor 459 provides demultiplexing between transport and logical channels, packet reassembly, decryption, header decompression, and control signal processing to recover upper-layer data packets from the core network. The upper-layer data packets are then provided to all protocol layers above L2. Various control signals may also be provided to L3 for L3 processing. The controller/processor 459 is also responsible for error detection using ACKnowledgement (ACK) and/or Negative ACKnowledgement (NACK) protocols to support HARQ operations.

In transmission from the second communication device 450 to the first communication device 410, at the second communication device 450, a data source 467 is used to provide upper-layer data packets to the controller/processor 459. The data source 467 represents all protocol layers above L2. Similar to the transmission functions at the first communication device 410 described in the DL, the controller/processor 459 implements header compression, encryption, packet segmentation and reordering, and multiplexing between logical and transport channels based on radio resource allocation from the first communication device 410, and implements L2 functions for the user plane and control plane. The controller/processor 459 is also responsible for HARQ operations, retransmission of lost packets, and signaling to the first communication device 410. The transmit processor 468 performs modulation mapping and channel coding processing, the multi-antenna transmit processor 457 performs digital multi-antenna spatial precoding (including codebook-based precoding and non-codebook-based precoding) and beamforming processing, and the transmit processor 468 then modulates the generated parallel streams into a multi-carrier/single-carrier symbol stream, which is subjected to analog precoding/beamforming operations in the multi-antenna transmit processor 457 and then provided to different antennas 452 via the transmitter 454. Each transmitter 454 first converts the baseband symbol stream provided by the multi-antenna transmit processor 457 into an RF symbol stream, which is then provided to the antenna 452.

In transmission from the second communication device 450 to the first communication device 410, the functions at the first communication device 410 are similar to the receive functions at the second communication device 450 described in the transmission from the first communication device 410 to the second communication device 450. Each receiver 418 receives RF signals through its corresponding antenna 420, converts the received RF signals into baseband signals, and provides the baseband signals to the multi-antenna receive processor 472 and the receive processor 470. The receive processor 470 and the multi-antenna receive processor 472 jointly implement L1 functions. The controller/processor 475 implements L2 functions. The controller/processor 475 may be associated with a memory 476 that stores program codes and data. The memory 476 may be referred to as a computer-readable medium. The controller/processor 475 provides demultiplexing between transport and logical channels, packet reassembly, decryption, header decompression, and control signal processing to recover upper-layer data packets from the second communication device 450. Upper-layer data packets from the controller/processor 475 may be provided to the core network. The controller/processor 475 is also responsible for error detection using ACK and/or NACK protocols to support HARQ operations.

In one embodiment, the second communication device 450 includes: at least one processor and at least one memory, the at least one memory including computer program code; the at least one memory and the computer program code are configured to be used together with the at least one processor. The second communication device 450 at least receives the first information block in this application, where the first information block indicates a process for the first RS resource in this application; the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, the second communication device 450 includes: a memory storing a computer-readable instruction program that, when executed by at least one processor, generates actions including receiving the first information block in this application.

In one embodiment, the first communication device 410 includes: at least one processor and at least one memory, the at least one memory including computer program code; the at least one memory and the computer program code are configured to be used together with the at least one processor. The first communication device 410 at least transmits the first information block in this application, where the first information block indicates a process for the first RS resource in this application; a receiver of the first information block is the second communication device 450; the process for the first RS resource set includes the second communication device 450 measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, the first communication device 410 includes: a memory storing a computer-readable instruction program that, when executed by at least one processor, generates actions including transmitting the first information block in this application.

In one embodiment, the first node in this application includes the second communication device 450.

In one embodiment, the second node in this application includes the first communication device 410.

In one embodiment, at least one of the antennas 420, the transmitter 418, the transmit processor 416, the multi-antenna transmit processor 471, the controller/processor 475, or the memory 476 is used to transmit the first information block in this application; at least one of the antennas 452, the receiver 454, the receive processor 456, the multi-antenna receive processor 458, the controller/processor 459, the memory 460, or the data source 467 is used to receive the first information block in this application.

### Embodiment 5

Embodiment 5 illustrates a flowchart of transmission between a first node and a second node according to one embodiment of the present application, as shown in FIG. 5. In FIG. 5, the first node U1 communicates with the second node N2 through a wireless link. It is specifically noted that the order in this embodiment does not limit the signal transmission order and implementation order in this application.

For the first node U1, receive a first information block in step S510.

For the second node N2, transmit a first information block in step S520.

In Embodiment 5, the first information block indicates a process for a first RS resource; the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, the first node U1 is the first node in this application.

In one embodiment, the second node N2 is the second node in this application.

In one embodiment, an air interface between the second node N2 and the first node U1 includes a radio interface between a base station device and a UE.

In one embodiment, an air interface between the second node N2 and the first node U1 includes a radio interface between a relay node device and a UE.

In one embodiment, an air interface between the second node N2 and the first node U1 includes a radio interface between a user equipment and a UE.

In one embodiment, the second node N2 and the first node U1 communicate via a Uu interface.

In one embodiment, the second node N2 is a maintaining base station of a serving cell of the first node U1.

In one embodiment, a transport channel occupied by the first information block includes a DownLink-Shared CHannel (DL-SCH).

In one embodiment, a physical layer channel occupied by the first information block includes a Physical Downlink Shared CHannel (PDSCH).

### Embodiment 6

Embodiment 6 illustrates a schematic diagram of the relationship between priority and priority value according to one embodiment of the present application, as shown in FIG. 6. In FIG. 6, the lower the priority value, the higher the priority, and the priority value is an integer.

In one embodiment, when the process for the first RS resource includes for CSI reporting, the first priority value is equal to a first integer; when the process for the first RS resource does not include CSI reporting, the first priority value is equal to a second integer; the first integer is a non-negative integer, the second integer is a positive integer, and the second integer is greater than the first integer.

In one embodiment, the first integer is equal to 0.

In one embodiment, the first integer is a positive integer.

In one embodiment, the second integer is a positive integer.

In one embodiment, the process for the first RS resource includes CSI reporting, the process for a second RS resource does not include for CSI reporting, and the priority value of the process for the first RS resource is higher than the priority value of the process for the second RS resource.

In one sub-embodiment of the embodiment, the second RS resource is the first RS resource.

In one sub-embodiment of the embodiment, the second RS resource is an RS resource other than the first RS resource.

In one sub-embodiment of the embodiment, the second RS resource and the first RS resource belong to a same RS resource set.

In one sub-embodiment of the embodiment, the second RS resource is a CSI-RS resource.

In one sub-embodiment of the embodiment, the second RS resource is an SSB.

In one sub-embodiment of the embodiment, the second RS resource is periodic or the second RS resource is semi-persistent.

### Embodiment 7

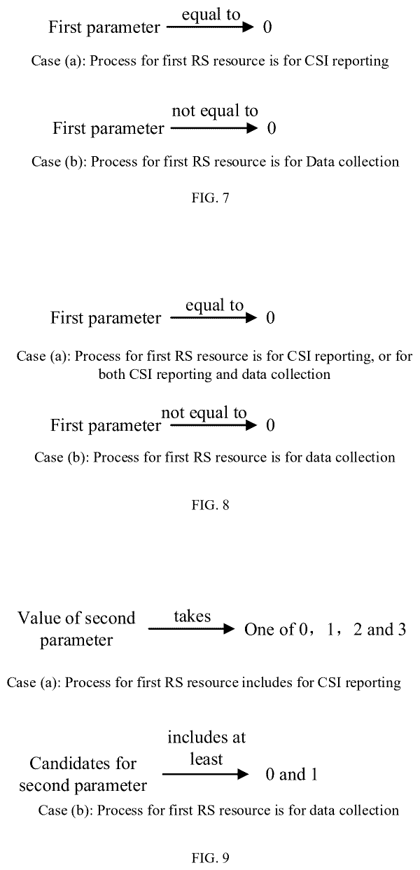

Embodiment 7 illustrates a first schematic diagram of two cases of a first parameter according to one embodiment of the present application, as shown in FIG. 7. In FIG. 7, case (a) indicates that when the process for the first RS resource is for CSI reporting, the first parameter is equal to 0; case (b) indicates that when the process for the first RS resource is for data collection, the first parameter is not equal to 0.

In Embodiment 7, the process for the first RS resource is only for CSI reporting or only for data collection.

In one embodiment, the process for the first RS resource is only for CSI reporting or only for data collection.

In one embodiment, the process for the first RS resource being only for CSI reporting or only for data collection means that the process for the first RS resource is for CSI reporting, or the process for the first RS resource is for data collection.

In one embodiment, the process for the first RS resource being only for CSI reporting or only for data collection means that the process for the first RS resource is not simultaneously for CSI reporting and data collection.

In one embodiment, the process for the first RS resource being only for CSI reporting or only for data collection means that the first node does not intend the process for the first RS resource to be simultaneously for CSI reporting and data collection.

In one embodiment, the process for the first RS resource being only for CSI reporting or only for data collection means that if the process for the first RS resource includes CSI reporting, then the process for the first RS resource is for CSI reporting; if the process for the first RS resource does not include CSI reporting, then the process for the first RS resource is for data collection.

In one embodiment, when the process for the first RS resource is for CSI reporting, the first parameter is equal to 0.

In one embodiment, when the process for the first RS resource is for data collection, the first parameter is not equal to 0.

In one embodiment, when the process for the first RS resource is for data collection, the first parameter is fixed or configured via higher-layer signaling.

In one embodiment, candidates for the first parameter include 0 and 1.

In one embodiment, the first parameter is equal to 0 or 1.

In one embodiment, candidates for the first parameter include 0 and 1; when the process for the first RS resource is for CSI reporting, the first parameter is equal to 0; when the process for the first RS resource is for data collection, the first parameter is equal to 1.

In one embodiment, the first parameter is equal to a product of a first factor and a second factor, and candidates for the first factor include 0 and 1.

In one sub-embodiment of the embodiment, when the process for the first RS resource is for CSI reporting, the first factor is equal to 0; when the process for the first RS resource is for data collection, the first factor is equal to 1.

In one sub-embodiment of the embodiment, when the process for the first RS resource is for CSI reporting, the first parameter is equal to 0; when the process for the first RS resource is for data collection, the first parameter is equal to the second factor.

In one sub-embodiment of the embodiment, the second factor is equal to a product of K, a first coefficient, and a second coefficient; the second coefficient is a maximum value between a maximum number of processes for CSI reporting and a maximum number of processes for data collection of the first node; K is an integer not less than 8.

In one auxiliary embodiment of the sub-embodiment, K is equal to 8.

In one auxiliary embodiment of the sub-embodiment, K is configurable.

In one auxiliary embodiment of the sub-embodiment, the first coefficient is a maximum value between a maximum number of cells for processes for CSI reporting and a maximum number of cells for processes for data collection of the first node.

In one auxiliary embodiment of the sub-embodiment, the first coefficient is a maximum number of cells configured for the first node.

In one auxiliary embodiment of the sub-embodiment, the first coefficient is indicated by the higher-layer parameter maxNrofServingCells.

In one auxiliary embodiment of the sub-embodiment, the second coefficient is indicated by maxNrofCSI-ReportConfigurations.

In one auxiliary embodiment of the sub-embodiment, the second coefficient is indicated by maxNrofDataCollectionConfigurations.

In one auxiliary embodiment of the sub-embodiment, the second coefficient is equal to a maximum value of both maxNrofCSI-ReportConfigurations and maxNrofDataCollectionConfigurations.

In one auxiliary embodiment of the sub-embodiment, when the process for the first RS resource is for CSI reporting, the first parameter is equal to 0; when the process for the first RS resource is for data collection, the first parameter is equal to a product of K, the first coefficient, and the second coefficient.

In one embodiment, the first priority value is linearly related to the first parameter.

### Embodiment 8

Embodiment 8 illustrates a second schematic diagram of two cases of a first parameter according to one embodiment of the present application, as shown in FIG. 8. In FIG. 8, case (a) indicates that when the process for the first RS resource is for CSI reporting or for both CSI reporting and data collection, the first parameter is equal to 0; case (b) indicates that when the process for the first RS resource is for data collection, the first parameter is not equal to 0.

In Embodiment 8, the process for the first RS resource is for CSI reporting, for data collection, or for both CSI reporting and data collection.

In one embodiment, candidates for the process for the first RS resource include three types: for CSI reporting, for data collection, for both CSI reporting and data collection.

In one embodiment, the process for the first RS resource being for CSI reporting, for data collection, or for both CSI reporting and data collection means that the process for the first RS resource is only for CSI reporting, or only for data collection, or simultaneously for both CSI reporting and data collection.

In one embodiment, the process for the first RS resource being for CSI reporting, for data collection, or for both CSI reporting and data collection means that the first node supports the process for the first RS resource to be simultaneously for both CSI reporting and data collection.

In one embodiment, the process for the first RS resource being for CSI reporting, for data collection, or for both CSI reporting and data collection means that if the process for the first RS resource includes for CSI reporting, then the process for the first RS resource is for CSI reporting or the process for the first RS resource is for both CSI reporting and data collection; if the process for the first RS resource does not include for CSI reporting, then the process for the first RS resource is for data collection.

In one embodiment, the process for the first RS resource being for both CSI reporting and data collection means that the process for the first RS resource includes generating first channel information, and the first channel information is associated with a CSI reporting configuration and a data collection configuration.

In one embodiment, the process for the first RS resource being for both CSI reporting and data collection means that the first RS resource is simultaneously associated with a CSI reporting configuration and a data collection configuration, and the CSI reporting configuration and the data collection configuration respectively instruct the first node to measure and calculate the first channel information.

In one embodiment, the process for the first RS resource being for both CSI reporting and data collection means that the process for the first RS resource includes generating first channel information, the first channel information is transmitted to the second node in this application through CSI reporting, and the first node stores the first channel information and transmits it to the second node in this application through a data set.

In one embodiment, the first channel information in this application includes one or more of Channel Quality Indicator (CQI), Precoding Matrix Indicator (PMI), CSI-RS Resource Indicator (CRI), SS/PBCH Block Resource Indicator (SSBRI), Layer Indicator (LI), Rank Indicator (RI), Layer 1 Reference Signal Received Power (L1-RSRP), Layer 1 Signal-to-Interference and Noise Ratio (L1-SINR), CapabilityIndex, and Capability[set]Index.

In one embodiment, when the process for the first RS resource is for CSI reporting or for both CSI reporting and data collection, the first parameter is equal to 0.

In one embodiment, when the process for the first RS resource does not include CSI reporting, the first parameter is not equal to 0.

In one embodiment, when the process for the first RS resource is for data collection, the first parameter is not equal to 0.

In one embodiment, when the process for the first RS resource does not include CSI reporting, the first parameter is fixed or configured via higher-layer signaling.

In one embodiment, when the process for the first RS resource is for data collection, the first parameter is fixed or configured via higher-layer signaling.

In one embodiment, candidates for the first parameter include 0 and 1.

In one embodiment, the first parameter is equal to 0 or 1.

In one embodiment, candidates for the first parameter include 0 and 1; when the process for the first RS resource is for CSI reporting or for both CSI reporting and data collection, the first parameter is equal to 0; when the process for the first RS resource is for data collection, the first parameter is equal to 1.

In one embodiment, candidates for the first parameter include 0 and 1; when the process for the first RS resource includes for CSI reporting, the first parameter is equal to 0; when the process for the first RS resource does not include CSI reporting, the first parameter is equal to 1.

In one embodiment, the first parameter is equal to a product of a first factor and a second factor, and candidates for the first factor include 0 and 1.

In one sub-embodiment of the embodiment, when the process for the first RS resource includes for CSI reporting, the first factor is equal to 0; when the process for the first RS resource does not include CSI reporting, the first factor is equal to 1.

In one sub-embodiment of the embodiment, when the process for the first RS resource is for CSI reporting or for both CSI reporting and data collection, the first factor is equal to 0; when the process for the first RS resource is for data collection, the first factor is equal to 1.

In one sub-embodiment of the embodiment, when the process for the first RS resource includes for CSI reporting, the first parameter is equal to 0; when the process for the first RS resource does not include CSI reporting, the first parameter is equal to the second factor.

In one sub-embodiment of the embodiment, when the process for the first RS resource is for CSI reporting or for both CSI reporting and data collection, the first parameter is equal to 0; when the process for the first RS resource is for data collection, the first parameter is equal to the second factor.

In one sub-embodiment of the embodiment, the second factor is equal to a product of K, a first coefficient, and a second coefficient; the second coefficient is a maximum value between a maximum number of processes for CSI reporting and a maximum number of processes for data collection of the first node; K is an integer not less than 8.

In one auxiliary embodiment of the sub-embodiment, K is equal to 8.

In one auxiliary embodiment of the sub-embodiment, K is configurable.

In one auxiliary embodiment of the sub-embodiment, the first coefficient is a maximum value between a maximum number of cells for processes for CSI reporting and a maximum number of cells for processes for data collection of the first node.

In one auxiliary embodiment of the sub-embodiment, the first coefficient is a maximum number of cells configured for the first node.

In one auxiliary embodiment of the sub-embodiment, the first coefficient is indicated by the higher-layer parameter maxNrofServingCells.

In one auxiliary embodiment of the sub-embodiment, the second coefficient is indicated by maxNrofCSI-ReportConfigurations.

In one auxiliary embodiment of the sub-embodiment, the second coefficient is indicated by maxNrofDataCollectionConfigurations.

In one auxiliary embodiment of the sub-embodiment, the second coefficient is equal to a maximum value of both maxNrofCSI-ReportConfigurations and maxNrofDataCollectionConfigurations.

In one auxiliary embodiment of the sub-embodiment, when the process for the first RS resource includes for CSI reporting, the first parameter is equal to 0; when the process for the first RS resource does not include CSI reporting, the first parameter is equal to a product of K, the first coefficient, and the second coefficient.

In one auxiliary embodiment of the sub-embodiment, when the process for the first RS resource is for CSI reporting or for both CSI reporting and data collection, the first parameter is equal to 0; when the process for the first RS resource is for data collection, the first parameter is equal to a product of K, the first coefficient, and the second coefficient.

In one embodiment, when the process for the first RS resource is for CSI reporting or for both CSI reporting and data collection, the first priority value is equal to a priority value associated with the CSI reporting.

In one embodiment, when the process for the first RS resource includes for CSI reporting, the first priority value is equal to a priority value associated with the CSI reporting.

In one embodiment, when the process for the first RS resource is for data collection, the first priority value is greater than a priority value associated with any CSI reporting configured for the first node.

In one embodiment, the first priority value is linearly related to the first parameter.

Embodiment 9

Embodiment 9 illustrates a schematic diagram of two cases of candidates for a second parameter according to one embodiment of the present application, as shown in FIG. 9. In FIG. 9, case (a) indicates that when the process for the first RS resource includes for CSI reporting, the second parameter takes one of 0, 1, 2, and 3; case (b) indicates that when the process for the first RS resource is for data collection, candidates for the second parameter include at least 0 and 1.

In Embodiment 9, the first priority value depends on the second parameter; the first parameter is different from the second parameter.

In one embodiment, the first priority value depends on the second parameter.

In one embodiment, the first priority value depends on both the first parameter and the second parameter, and the first parameter is different from the second parameter.

In one embodiment, the first parameter depends on whether the process for the first RS resource includes CSI reporting.

In one embodiment, the second parameter depends on whether the process for the first RS resource includes CSI reporting; when the process for the first RS resource includes for CSI reporting, the second parameter takes one of 0, 1, 2, and 3; when the process for the first RS resource is for data collection, candidates for the second parameter include at least 0 and 1.

In one embodiment, when the process for the first RS resource includes for CSI reporting, the second parameter depends on the time-domain behavior of the CSI reporting; the above method has good compatibility.

In one sub-embodiment of the embodiment, when the CSI reporting is an aperiodic CSI reporting carried by a Physical Uplink Shared Channel (PUSCH), the second parameter is equal to 0; when the CSI reporting is a semi-persistent CSI reporting carried by a PUSCH, the second parameter is equal to 1; when the CSI reporting is a semi-persistent CSI reporting carried by a Physical Uplink Control Channel (PUCCH), the second parameter is equal to 2; when the CSI reporting is a periodic CSI reporting carried by a PUCCH, the second parameter is equal to 3.

In one embodiment, when the process for the first RS resource is for data collection, the second parameter is configured by the second node in this application; the above method has greater flexibility and helps the network indicate that more important data is collected earlier.

In one embodiment, when the process for the first RS resource is for data collection, the second parameter depends on the time-domain behavior of the data collection; the above method has good compatibility.

In one sub-embodiment of the embodiment, candidates for the second parameter are 0 and 1; when the data collection is periodic data collection, the second parameter is equal to 0; when the data collection is semi-persistent data collection, the second parameter is equal to 1.

In one sub-embodiment of the embodiment, candidates for the second parameter are 0 and 1; when the data set corresponding to the process for the first RS resource already includes measurement data obtained by measuring the first RS resource, the second parameter is equal to 0; when the data set corresponding to the process for the first RS resource does not yet include measurement data obtained by measuring the first RS resource, the second parameter is equal to 1; the above method ensures the continuity of data collection.

In one sub-embodiment of the embodiment, candidates for the second parameter are 0 and 1; the first node performs the data collection for the first RS resource every first time duration; when the first node has performed the process for the first RS resource within a second time duration, the second parameter is equal to 0; when the first node has not performed the process for the first RS resource within the second time duration, the second parameter is equal to 1; the second time duration is not less than the first time duration; the above method ensures the continuity of data collection.

In one auxiliary embodiment of the sub-embodiment, the first time duration and the second time duration each include a positive integer number of subframe(s).

In one auxiliary embodiment of the sub-embodiment, the first time duration and the second time duration each include a positive integer number of slot(s).

In one auxiliary embodiment of the sub-embodiment, the first time duration and the second time duration each include a positive integer number of symbol(s).

In one auxiliary embodiment of the sub-embodiment, the first time duration and the second time duration each include a positive integer number of millisecond(s).

In one auxiliary embodiment of the sub-embodiment, the first time duration is indicated by higher-layer signaling.

In one auxiliary embodiment of the sub-embodiment, the second time duration is N times the first time duration, where N is a positive integer; N is configured by higher-layer signaling or predefined.

In one embodiment, when the process for the first RS resource is for data collection, the second parameter depends on the data type included in the data collection; the above method allows a data collection process to collect multiple data types simultaneously, and ensures that more important data is collected first by predefining important data types.

In one sub-embodiment of the embodiment, candidates for the second parameter are 0 and 1; when the data collection is for physical layer data, the second parameter is equal to 0; when the data collection is for higher-layer data, the second parameter is equal to 1.

In one sub-embodiment of the embodiment, candidates for the second parameter are 0, 1, 2, and 3; when the data collection is for coding and decoding data, the second parameter is equal to 0; when the data collection is for physical layer data, the second parameter is equal to 1; when the data collection is for mobility management data, the second parameter is equal to 2; when the data collection is for positioning data, the second parameter is equal to 3.

In one sub-embodiment of the embodiment, candidates for the type of data collection include P1 types, and candidates for the second parameter include P2 non-negative integers not greater than (P2-1); the data collection for the first RS resource is a target type, which is one of the P1 types; the target type is used to indicate a target integer value from the P2 non-negative integers, and the second parameter is equal to the target integer value; P1 and P2 are each positive integers greater than 1, and P1 is not less than P2.

In one embodiment, the first priority value is linearly related to the second parameter.

In one embodiment, the first priority value is linearly related to the first parameter, and the first priority value is linearly related to the second parameter.

In one embodiment, the first priority value is equal to a sum of a first addend and a candidate addend; the first addend depends on the first parameter, and the candidate addend depends on the second parameter.

In one sub-embodiment of the embodiment, the first addend is equal to the first parameter.

In one sub-embodiment of the embodiment, the first addend is linearly related to the first parameter.

In one sub-embodiment of the embodiment, the candidate addend is linearly related to the second parameter.

In one sub-embodiment of the embodiment, the candidate addend is linearly related to a product of the second parameter, the first coefficient in this application, the second coefficient in this application, and 2.

### Embodiment 10

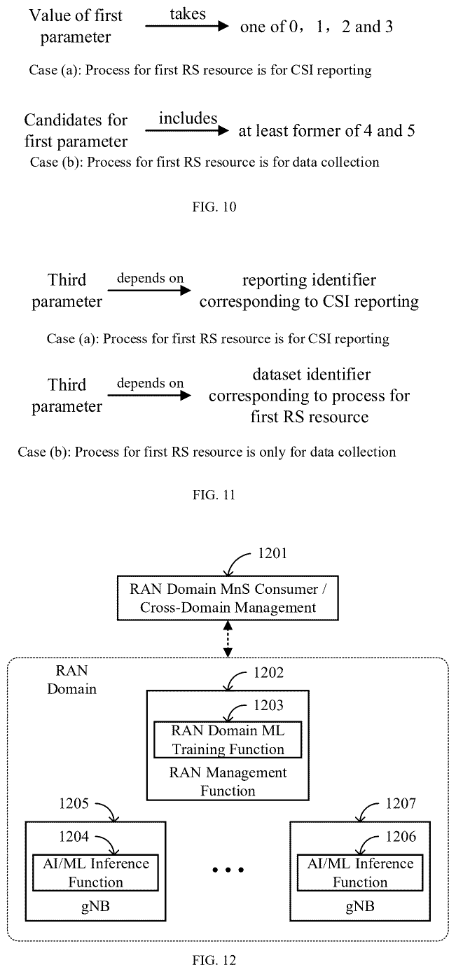

Embodiment 10 illustrates a third schematic diagram of two cases of a first parameter according to one embodiment of the present application, as shown in FIG. 10. In FIG. 10, case (a) indicates that when the process for the first RS resource is for CSI reporting, the first parameter takes one of 0, 1, 2, and 3; case (b) indicates that when the process for the first RS resource is for data collection, candidates for the first parameter include at least the former of 4 and 5.

In one embodiment, when the process for the first RS resource is for CSI reporting, a value of the first parameter depends on a time-domain behavior of the CSI reporting.

In one sub-embodiment of the embodiment, when the CSI reporting is an aperiodic CSI reporting carried by a Physical Uplink Shared Channel (PUSCH), the first parameter is equal to 0; when the CSI reporting is a semi-persistent CSI reporting carried by a PUSCH, the first parameter is equal to 1; when the CSI reporting is a semi-persistent CSI reporting carried by a Physical Uplink Control Channel (PUCCH), the first parameter is equal to 2; when the CSI reporting is a periodic CSI reporting carried by a PUCCH, the first parameter is equal to 3.

In one embodiment, when the process for the first RS resource is for data collection, the first parameter depends on a time-domain behavior of the data collection; the above method has good compatibility.

In one sub-embodiment of the embodiment, candidates for the first parameter are 4 and 5; when the data collection is periodic data collection, the first parameter is equal to 4; when the data collection is semi-persistent data collection, the first parameter is equal to 5.

In one sub-embodiment of the embodiment, candidates for the first parameter are 4 and 5; when the first RS resource is a periodic RS resource, the first parameter is equal to 4; when the first RS resource is a semi-persistent RS resource, the first parameter is equal to 5.

In one embodiment, when the process for the first RS resource is for CSI reporting, the first parameter is one of 0, 1, 2, and 3; when the process for the first RS resource is for data collection, the first parameter is 4; the above method is simple to implement.

In one embodiment, the first priority value is linearly related to the first parameter.

In one embodiment, the first priority value is linearly related to a product of the first parameter, the first coefficient, the second coefficient, and 2.

### Embodiment 11

Embodiment 11 illustrates a schematic diagram of a third parameter according to one embodiment of the present application, as shown in FIG. 11. In FIG. 11, case (a) indicates that when the process for the first RS resource includes for CSI reporting, the third parameter depends on a reporting identifier corresponding to the CSI reporting; case (b) indicates that when the process for the first RS resource is only for data collection, the third parameter depends on a data set identifier corresponding to the process for the first RS resource.

In Embodiment 11, the first priority value depends on a third parameter.

In one embodiment, the first priority value depends on a third parameter.

In one embodiment, the first priority value is linearly related to a third parameter.

In one embodiment, the first priority value depends on both the first parameter and the third parameter, and the first parameter is different from the third parameter.

In one embodiment, the first priority value depends on the first parameter, the second parameter, and the third parameter, and the first parameter, the second parameter, and the third parameter are all different.

In one embodiment, when the process for the first RS resource includes for CSI reporting, the third parameter depends on a reporting identifier corresponding to the CSI reporting.

In one embodiment, when the process for the first RS resource includes for CSI reporting, the third parameter is linearly related to a reporting identifier corresponding to the CSI reporting.

In one embodiment, when the process for the first RS resource includes for CSI reporting, the third parameter is equal to a reporting identifier corresponding to the CSI reporting.

In one embodiment, when the process for the first RS resource includes for CSI reporting, a reporting identifier corresponding to the CSI reporting is indicated by a higher-layer signaling reportConfigID.

In one embodiment, when the process for the first RS resource includes for CSI reporting, a reporting identifier corresponding to the CSI reporting is indicated by a higher-layer signaling LTM-CSI-ReportConfig.

In one embodiment, when the process for the first RS resource is only for data collection, the third parameter depends on a data set identifier corresponding to the process for the first RS resource.

In one embodiment, when the process for the first RS resource is only for data collection, the third parameter is linearly related to a data set identifier corresponding to the process for the first RS resource.

In one embodiment, when the process for the first RS resource is only for data collection, the third parameter is equal to a data set identifier corresponding to the process for the first RS resource.

In one embodiment, when the process for the first RS resource is only for data collection, a data set identifier corresponding to the process for the first RS resource is indicated by higher-layer signaling collectionConfigID.

In one embodiment, when the process for the first RS resource is only for data collection, a data set identifier corresponding to the process for the first RS resource is indicated by higher-layer signaling dataCollectionConfigID.

In one embodiment, when the process for the first RS resource is only for data collection, a data set identifier corresponding to the process for the first RS resource is indicated by higher-layer signaling dataSetID.

### Embodiment 12

Embodiment 12 illustrates a schematic diagram of RAN domain AI/ML function deployment according to one embodiment of the present application, as shown in FIG. 12. In FIG. 12, the gNB may be replaced with network devices such as an eNB or a 6G base station.

In Embodiment 12, the management of ML inference functions of multiple base stations is performed by the RAN domain management function 1202, i.e., data interaction with the RAN domain Management Service (MnS) consumer/cross-domain management 1201 (as indicated by the dashed arrows in FIG. 12). The RAN domain ML training function 1203 is located in the RAN domain management function 1202; while the ML inference functions are located in the base stations, i.e., the AI/ML inference function 1204 is located in the gNB 1205, the AI/ML inference function 1206 is located in the gNB 1207, and so on.

AI/ML-related functions include ML training function (also referred to as AI training or AI/ML training), ML testing function, ML inference function (also referred to as AI inference or AI/ML inference), etc. The ML training function, ML testing function, and ML inference function may be deployed independently or co-located. The deployment of AI/ML-related functions may be implemented through software, such as downloading and/or running executable files; it may also be implemented through a combination of software and hardware, such as accelerating specific computing units through hardware to improve computing speed or save power consumption.

For the ML training function, it may be deployed in a cross-domain management system or a domain-specific management system; the domain-specific management system is used to manage the RAN domain or Core Network (CN) domain. For example, the ML training function for Management Data Analytics (MDA) may be deployed in a Management Data Analytic Function (MDAF); the ML training for network data analytics may be deployed in a Network Data Analytics Function (NWDAF), i.e., the ML training function is a Model Training Logical Function (MTLF).

For the ML inference function, it may also be deployed in a cross-domain management system or a domain-specific management system; for example, the ML inference function is an MDAF, or the ML inference function is an Analytics Logical Function (AnLF) located in the NWDAF.

Similarly, the ML testing function may also be deployed in a cross-domain management system or a domain-specific management system.

Optionally, the management of the ML inference function may also be performed by the base stations themselves, i.e., each base station may independently perform data interaction with the RAN domain MnS consumer/cross-domain management 1201.

It should be noted that Embodiment 12 is merely a non-limiting implementation; optionally, the RAN domain ML training function may also be deployed in the base stations; or alternatively, some base stations deploy both the ML inference function and the RAN domain ML training function, while other base stations only deploy the ML inference function.

In one embodiment, a gNB (or base station) in Embodiment 12 is the second node in this application.

### Embodiment 13

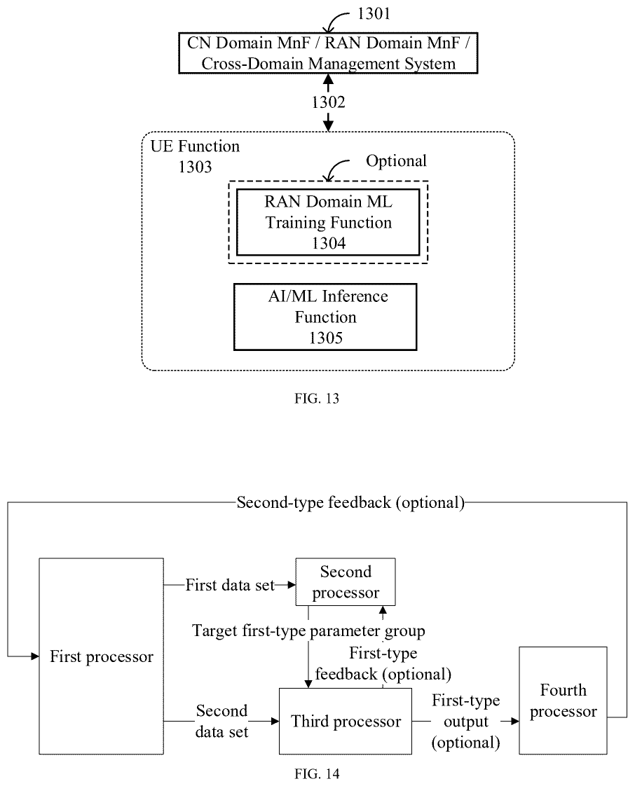

Embodiment 13 illustrates a schematic diagram of UE AI/ML function deployment according to one embodiment of the present application, as shown in FIG. 13. In FIG. 13, the RAN domain ML training function 1304 is optional.

The UE function 1303 is deployed in the first node in this application, and the UE function 1303 includes an AI/ML inference function 1305; the AI/ML inference function 1305 performs inference using an ML model (also referred to as an AI model); an ML model usually needs to be trained before being used for AI/ML inference.

In one embodiment, the UE function 1303 includes a RAN domain ML training function 1304, which runs training data through the ML model to derive relevant loss, and adjusts parameters of the ML model based on the calculated loss; the ML training includes at least one of ML initial training, ML re-training, and reinforcement learning.

The above embodiment can reduce the complexity of the base station or save air interface resources caused by reporting training data; however, the above embodiment places higher requirements on the processing capability of the UE side.

Optionally, the UE function 1303 further includes a CN domain ML training function (not included in FIG. 13).

Optionally, the UE function 1303 further includes an AI/ML deployment function (not included in FIG. 13) for loading ML models and data.

In one embodiment, the first node indicates whether it supports the ML training function (RAN domain or CN domain) through capability reporting, and the capability reporting is RRC signaling or Non-Access Stratum (NAS) signaling.

In one embodiment, the ML model and related metadata are loaded by the first node from a network device or a remote server.

Optionally, the UE function 1303 is an MnS producer, providing data to the CN domain Management Function (MnF) and/or RAN domain MnF and/or cross-domain management system 1301 for management or analysis (as indicated by the double arrow 1302).

Optionally, the UE function 1303 is an MnS consumer, loading data from the CN domain MnF and/or RAN domain MnF and/or cross-domain management system 1301 for AI/ML-related management, such as management data requests, ML model activation, and/or ML training (as indicated by the double arrow 1302).

In one embodiment, the data collection in this application is used for the RAN domain ML training function 1304.

In one embodiment, the data collection in this application generates the relevant metadata.

In one embodiment, the UE function 1303 is an MnS producer, and the first node performs the data collection in this application to generate data.

In one embodiment, the first node is an MnS producer, and the first node provides data to the second node in this application by transmitting the second information block in this application.

In one embodiment, the ML model is based on Neural Networks (NN).

In one embodiment, the ML model is based on Artificial Neural Networks (ANN).

In one embodiment, the ML model is based on Convolutional Neural Networks (CNN).

In one embodiment, the ML model is based on a Large Language Model (LLM) architecture.

In one embodiment, the ML model is based on a Transformer architecture.

In one embodiment, the ML model is based on Long Short-Term Memory (LSTM).

In one embodiment, the ML model is based on a MultiLayer Perceptron (MLP).

In one embodiment, the ML model is based on Generative Adversarial Nets (GAN).

In one embodiment, the ML model is based on a lightweight neural network.

In one sub-embodiment of the embodiment, the lightweight neural network includes one or more of MobileNet, ShuffleNet, and SqueezeNet.

### Embodiment 14

Embodiment 14 illustrates a schematic diagram of an artificial intelligence or machine learning-based processing system according to one embodiment of the present application, as shown in FIG. 14. In FIG. 14, the artificial intelligence or machine learning-based processing system includes a first processor, a second processor, a third processor, and a fourth processor.

In Embodiment 14, the first processor transmits a first data set to the second processor and a second data set to the third processor; the second processor generates a target first-type parameter group according to the first data set, and the second processor transmits the generated target first-type parameter group to the third processor; the third processor processes the second data set using the target first-type parameter group to obtain a first-type output; optionally, the third processor transmits the first-type output to the fourth processor. In FIG. 14, the first-type feedback and the second-type feedback are optional; the second processor includes an ML training function; the third processor includes an ML inference function.

In one embodiment, the fourth processor includes an ML testing function.

In one embodiment, the fourth processor includes performance monitoring/evaluation of the ML model.

In one embodiment, the third processor transmits first-type feedback to the second processor; the first-type feedback is used to trigger recalculation or update of the target first-type parameter group, i.e., trigger ML initial training or ML re-training.

In one embodiment, the fourth processor transmits second-type feedback to the first processor; the second-type feedback is used to generate the first data set or the second data set, or the second-type feedback is used to trigger sending transmission of the first data set or the second data set.

In one embodiment, the first processor generates the first data set and the second data set according to measurements of reference signals.

In one embodiment, the third processor belongs to the first node, and the fourth processor belongs to the second node.

In one embodiment, the third processor belongs to the first node.

In one embodiment, the first data set includes training data.

In one embodiment, the first data set includes a data set generated by the first node performing data collection.

In one embodiment, a data set generated by the first node performing data collection includes the first data set.

In one embodiment, the second processor is used to train an ML model, and the trained model is described by the target first-type parameter group.

In one embodiment, the second processor belongs to the first node; the above method avoids transmitting the first data set to the second node.

In one embodiment, the second processor belongs to the second node in this application; the above method supports joint training and optimizes system performance.

In one embodiment, the second processor belongs to the core network; the above method supports network-wide joint training and further optimizes system performance.

In one embodiment, the second data set includes inference data.

In one embodiment, the third processor constructs a model according to the target first-type parameter group, and then inputs the second data set into the constructed model to obtain the first-type output.

In one embodiment, the third processor generates a recovery data set according to the first-type output, and an error between the recovery data set and the second data set is used to generate the first-type feedback.

In one embodiment, the first-type feedback is used to reflect the performance of the trained model; when the performance of the trained model fails to meet requirements, the second processor recalculates the target first-type parameter group.

In one embodiment, the performance of the trained model is considered to fail to meet requirements when the error is too large or no update has been made for a long time.

In one embodiment, the target first-type parameter group includes one or more of a kernel, a pool core, a pooling function, an activation function, parameters of the pooling function, or parameters of the activation function.

In one embodiment, the target first-type parameter group includes one or more of kernel size, number of convolution layers, convolution stride, pool core size, pool core stride, pooling function, activation function, or number of feature maps.

### Embodiment 15

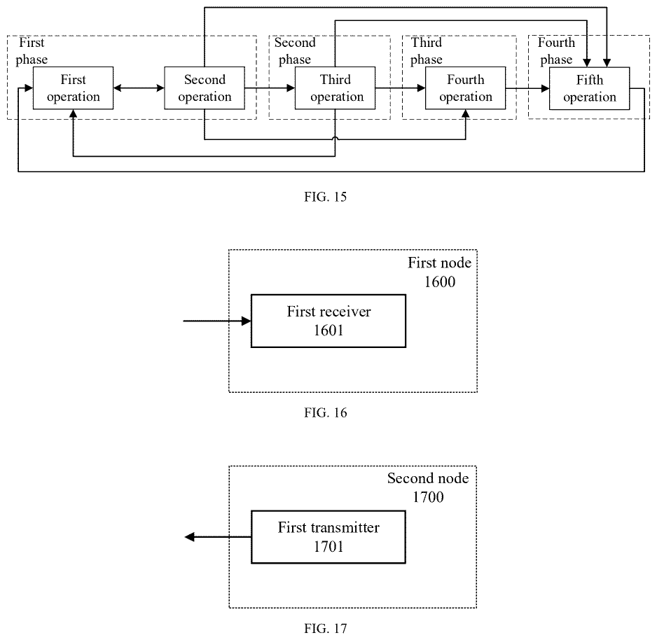

Embodiment 15 illustrates a schematic diagram based on artificial intelligence or machine learning according to one embodiment of the present application, as shown in FIG. 15. In FIG. 15, the first operation and the second operation belong to the first phase, the third operation belongs to the second phase, the fourth operation belongs to the third phase, and the fifth operation belongs to the fourth phase; the lines with arrows indicate the order of the process.

In one embodiment, the first operation includes AI/ML training, the second operation includes AI/ML testing, the third operation includes AI/ML emulation, the fourth operation includes AI/ML entity loading, and the fifth operation includes AI/ML inference.

In one embodiment, the first phase includes a training phase, the second phase includes an emulation phase, the third phase includes a deployment phase, and the fourth phase includes an inference phase.

In one embodiment, the first phase includes AI/ML model training.

In one embodiment, the first phase includes AI/ML model training and AI/ML testing.

In one embodiment, the AI/ML model training includes initial training and re-training of one or a group of AI/ML entities.

In one embodiment, the AI/ML model training relies on training data.

In one embodiment, the AI/ML model training relies on the first node performing the data collection.

In one embodiment, the AI/ML model training includes AI/ML entity validation.

In one embodiment, the AI/ML entity validation is used to evaluate the performance of the AI/ML entity.

In one embodiment, the AI/ML entity validation relies on validation data.

In one embodiment, if the result of the AI/ML entity validation fails to meet expectations, the AI/ML model will be re-trained.

In one embodiment, the AI/ML testing includes testing the validated AI/ML entity to evaluate the performance of the trained AI/ML model.

In one embodiment, if the result of the AI/ML testing meets expectations, the AI/ML entity proceeds to the next phase; otherwise, the AI/ML model will be re-trained.

In one embodiment, the AI/ML testing relies on test data.

In one embodiment, the second phase includes AI/ML emulation, which performs inference of the AI/ML entity in a simulated environment.

In one embodiment, the AI/ML emulation estimates the inference performance of the AI/ML entity in a simulated environment before using the AI/ML entity.

In one embodiment, the second phase is optional.

In one embodiment, the third phase includes AI/ML entity loading, which is used to obtain the trained AI/ML entity to achieve the desired AI/ML inference function.

In one embodiment, the third phase is optional.

In one embodiment, when the training function and the inference function are co-located, the third phase is no longer required.

In one embodiment, the fourth phase includes AI/ML inference.

### Embodiment 16

Embodiment 16 illustrates a structural block diagram of a processor in a first node according to one embodiment of the present application, as shown in FIG. 16. In FIG. 16, the processor 1600 in the first node includes a first receiver 1601.

In Embodiment 16, the first receiver 1601 receives a first information block, where the first information block indicates a process for a first RS resource.

In Embodiment 16, the process for the first RS resource set includes measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, when the process for the first RS resource includes for CSI reporting, the first priority value is equal to a first integer; when the process for the first RS resource does not include CSI reporting, the first priority value is equal to a second integer; the first integer is a non-negative integer, the second integer is a positive integer, and the second integer is greater than the first integer.

In one embodiment, the process for the first RS resource is only for CSI reporting or for data collection; when the process for the first RS resource is for CSI reporting, the first parameter is equal to 0; when the process for the first RS resource is for data collection, the first parameter is not equal to 0.

In one embodiment, the process for the first RS resource is for CSI reporting, for data collection, or for both CSI reporting and data collection; when the process for the first RS resource is for CSI reporting or for both CSI reporting and data collection, the first parameter is equal to 0; when the process for the first RS resource is for data collection, the first parameter is not equal to 0.

In one embodiment, the first priority value depends on a second parameter; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

In one embodiment, when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

In one embodiment, the first priority value depends on a third parameter; when the process for the first RS resource includes for CSI reporting, the third parameter depends on a reporting identifier corresponding to the CSI reporting; when the process for the first RS resource is only for data collection, the third parameter depends on a data set identifier corresponding to the process for the first RS resource.

Typically, the first priority value is equal to a sum of a first addend, a second addend, a third addend, and a fourth addend; the first addend is linearly related to the first parameter, and the fourth addend is linearly related to the third parameter.

In one sub-embodiment of the embodiment, the fourth addend is equal to the third parameter.

In one sub-embodiment of the embodiment, the third addend is equal to a product of L3, a first value, and the first dependent variable; L3 is equal to 1; the first dependent variable depends on a cell index corresponding to the process for the first RS resource.

In one sub-embodiment of the embodiment, the second addend is equal to a product of L2, a second value, a first value, and the second dependent variable; L2 is equal to 1; the second dependent variable takes a value of 0 or 1, and the second dependent variable depends on whether measurement information obtained by measuring the first RS resource includes L1-RSRP and/or L1-SINR.

In one sub-embodiment of the embodiment, the first addend is equal to a product of L1, a second value, a first value, and the first parameter; L1 is equal to 2; when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

In one auxiliary embodiment of the above three sub-embodiments, the first value is a maximum value between a maximum number of processes for CSI reporting and a maximum number of processes for data collection of the first node.

In one auxiliary embodiment of the above three sub-embodiments, the first value is indicated by maxNrofCSI-ReportConfigurations.

In one auxiliary embodiment of the above three sub-embodiments, the first value is indicated by maxNrofDataCollectionConfigurations.

In one auxiliary embodiment of the above three sub-embodiments, the first value is equal to a maximum value of both maxNrofCSI-ReportConfigurations and maxNrofDataCollectionConfigurations.

In one auxiliary embodiment of the above two sub-embodiments, the second value is a maximum value between a maximum number of cells for processes for CSI reporting and a maximum number of cells for processes for data collection of the first node.

In one auxiliary embodiment of the above two sub-embodiments, the second value is a maximum number of cells configured for the first node.

In one auxiliary embodiment of the above two sub-embodiments, the second value is indicated by the higher-layer parameter maxNrofServingCells.

Typically, the first priority value is equal to a sum of an enhanced addend, a first addend, a second addend, a third addend, and a fourth addend; the enhanced addend is linearly related to the first parameter, the first addend is linearly related to the second parameter, and the fourth addend is linearly related to the third parameter.

In one sub-embodiment of the embodiment, the fourth addend is equal to the third parameter.

In one sub-embodiment of the embodiment, the third addend is equal to a product of L3, a first value, and the first dependent variable; L3 is equal to 1; the first dependent variable depends on a cell index corresponding to the process for the first RS resource.

In one sub-embodiment of the embodiment, the second addend is equal to a product of L2, a second value, a first value, and the second dependent variable; L2 is equal to 1; the second dependent variable takes a value of 0 or 1, and the second dependent variable depends on whether measurement information obtained by measuring the first RS resource includes L1-RSRP and/or L1-SINR.

In one sub-embodiment of the embodiment, the first addend is equal to a product of L1, a second value, a first value, and the second parameter; L1 is equal to 2; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

In one sub-embodiment of the embodiment, the enhanced addend is equal to a product of L0, a second value, a first value, and the first parameter; when the process for the first RS resource includes for CSI reporting, the first parameter is equal to 0; when the process for the first RS resource is for data collection, the first parameter is not equal to 0; L0 is a positive integer not less than 8, and L0 is predefined.

In one auxiliary embodiment of the above four sub-embodiments, the first value is a maximum value between a maximum number of processes for CSI reporting and a maximum number of processes for data collection of the first node.

In one auxiliary embodiment of the above four sub-embodiments, the first value is indicated by maxNrofCSI-ReportConfigurations.

In one auxiliary embodiment of the above four sub-embodiments, the first value is indicated by maxNrofDataCollectionConfigurations.

In one auxiliary embodiment of the above four sub-embodiments, the first value is equal to a maximum value of both maxNrofCSI-ReportConfigurations and maxNrofDataCollectionConfigurations.

In one auxiliary embodiment of the above three sub-embodiments, the second value is a maximum value between a maximum number of cells for processes for CSI reporting and a maximum number of cells for processes for data collection of the first node.

In one auxiliary embodiment of the above three sub-embodiments, the second value is a maximum number of cells configured for the first node.

In one auxiliary embodiment of the above three sub-embodiments, the second value is indicated by the higher-layer parameter maxNrofServingCells.

In one embodiment, the first node 1600 is a user equipment.

In one embodiment, the first node 1600 is a terminal.

In one embodiment, the first node 1600 is a relay node device.

In one embodiment, the first receiver 1601 includes at least one of the antennas 452, the receiver 454, the receive processor 456, the multi-antenna receive processor 458, the controller/processor 459, the memory 460, or the data source 467 in Embodiment 4.

### Embodiment 17

Embodiment 17 illustrates a structural block diagram of a processor for a second node according to one embodiment of the present application, as shown in FIG. 17. In FIG. 17, the processor 1700 in the second node includes a first transmitter 1701.

In Embodiment 17, the first transmitter 1701 transmits a first information block, where the first information block indicates a process for a first RS resource.

In Embodiment 17, the process for the first RS resource set includes a receiver of the first information block measuring on the first RS resource; candidates for a process for the first RS resource include at least for CSI reporting and for data collection; the process for the first RS resource is associated with a first priority value, the first priority value depends on a first parameter, and the first parameter depends on whether the process for the first RS resource includes for CSI reporting.

In one embodiment, when the process for the first RS resource includes for CSI reporting, the first priority value is equal to a first integer; when the process for the first RS resource does not include CSI reporting, the first priority value is equal to a second integer; the first integer is a non-negative integer, the second integer is a positive integer, and the second integer is greater than the first integer.

In one embodiment, the process for the first RS resource is only for CSI reporting or for data collection; when the process for the first RS resource is for CSI reporting, the first parameter is equal to 0; when the process for the first RS resource is for data collection, the first parameter is not equal to 0.

In one embodiment, the process for the first RS resource is for CSI reporting, for data collection, or for both CSI reporting and data collection; when the process for the first RS resource is for CSI reporting or for both CSI reporting and data collection, the first parameter is equal to 0; when the process for the first RS resource is for data collection, the first parameter is not equal to 0.

In one embodiment, the first priority value depends on a second parameter; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

In one embodiment, when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

In one embodiment, the first priority value depends on a third parameter; when the process for the first RS resource includes for CSI reporting, the third parameter depends on a reporting identifier corresponding to the CSI reporting; when the process for the first RS resource is only for data collection, the third parameter depends on a data set identifier corresponding to the process for the first RS resource.

Typically, the first priority value is equal to a sum of a first addend, a second addend, a third addend, and a fourth addend; the first addend is linearly related to the first parameter, and the fourth addend is linearly related to the third parameter.

In one sub-embodiment of the embodiment, the fourth addend is equal to the third parameter.

In one sub-embodiment of the embodiment, the third addend is equal to a product of L3, a first value, and the first dependent variable; L3 is equal to 1; the first dependent variable depends on a cell index corresponding to the process for the first RS resource.

In one sub-embodiment of the embodiment, the second addend is equal to a product of L2, a second value, a first value, and the second dependent variable; L2 is equal to 1; the second dependent variable takes a value of 0 or 1, and the second dependent variable depends on whether measurement information obtained by measuring the first RS resource includes L1-RSRP and/or L1-SINR.

In one sub-embodiment of the embodiment, the first addend is equal to a product of L1, a second value, a first value, and the first parameter; L1 is equal to 2; when the process for the first RS resource is for CSI reporting, the first parameter depends on a time-domain behavior of the process for the first RS resource, and the first parameter takes one of 0, 1, 2, and 3; when the process for the first RS resource is for data collection, candidates for the first parameter include at least the former of 4 and 5.

In one auxiliary embodiment of the above three sub-embodiments, the first value is a maximum value between a maximum number of processes for CSI reporting and a maximum number of processes for data collection of the first node.

In one auxiliary embodiment of the above three sub-embodiments, the first value is indicated by maxNrofCSI-ReportConfigurations.

In one auxiliary embodiment of the above three sub-embodiments, the first value is indicated by maxNrofDataCollectionConfigurations.

In one auxiliary embodiment of the above three sub-embodiments, the first value is equal to a maximum value of both maxNrofCSI-ReportConfigurations and maxNrofDataCollectionConfigurations.

In one auxiliary embodiment of the above two sub-embodiments, the second value is a maximum value between a maximum number of cells for processes for CSI reporting and a maximum number of cells for processes for data collection of the first node.

In one auxiliary embodiment of the above two sub-embodiments, the second value is a maximum number of cells configured for the first node.

In one auxiliary embodiment of the above two sub-embodiments, the second value is indicated by the higher-layer parameter maxNrofServingCells.

Typically, the first priority value is equal to a sum of an enhanced addend, a first addend, a second addend, a third addend, and a fourth addend; the enhanced addend is linearly related to the first parameter, the first addend is linearly related to the second parameter, and the fourth addend is linearly related to the third parameter.

In one sub-embodiment of the embodiment, the fourth addend is equal to the third parameter.

In one sub-embodiment of the embodiment, the third addend is equal to a product of L3, a first value, and the first dependent variable; L3 is equal to 1; the first dependent variable depends on a cell index corresponding to the process for the first RS resource.

In one sub-embodiment of the embodiment, the second addend is equal to a product of L2, a second value, a first value, and the second dependent variable; L2 is equal to 1; the second dependent variable takes a value of 0 or 1, and the second dependent variable depends on whether measurement information obtained by measuring the first RS resource includes L1-RSRP and/or L1-SINR.

In one sub-embodiment of the embodiment, the first addend is equal to a product of L1, a second value, a first value, and the second parameter; L1 is equal to 2; when the process for the first RS resource includes for CSI reporting, the second parameter takes one of 0, 1, 2, and 3; when the process for the first RS resource is for data collection, candidates for the second parameter include at least 0 and 1; the first parameter is different from the second parameter.

In one sub-embodiment of the embodiment, the enhanced addend is equal to a product of L0, a second value, a first value, and the first parameter; when the process for the first RS resource includes for CSI reporting, the first parameter is equal to 0; when the process for the first RS resource is for data collection, the first parameter is not equal to 0; L0 is a positive integer not less than 8, and L0 is predefined.

In one auxiliary embodiment of the above four sub-embodiments, the first value is a maximum value between a maximum number of processes for CSI reporting and a maximum number of processes for data collection of the first node.

In one auxiliary embodiment of the above four sub-embodiments, the first value is indicated by maxNrofCSI-ReportConfigurations.

In one auxiliary embodiment of the above four sub-embodiments, the first value is indicated by maxNrofDataCollectionConfigurations.

In one auxiliary embodiment of the above four sub-embodiments, the first value is equal to a maximum value of both maxNrofCSI-ReportConfigurations and maxNrofDataCollectionConfigurations.

In one auxiliary embodiment of the above three sub-embodiments, the second value is a maximum value between a maximum number of cells for processes for CSI reporting and a maximum number of cells for processes for data collection of the first node.

In one auxiliary embodiment of the above three sub-embodiments, the second value is a maximum number of cells configured for the first node.

In one auxiliary embodiment of the above three sub-embodiments, the second value is indicated by the higher-layer parameter maxNrofServingCells.

In one embodiment, the second node 1700 is a base station device.

In one embodiment, the second node 1700 is a user equipment.

In one embodiment, the second node 1700 is a TRP.

In one embodiment, the first transmitter 1701 includes at least one of the antennas 420, the transmitter 418, the transmit processor 416, the multi-antenna transmit processor 471, the controller/processor 475, or the memory 476 in Embodiment 4.

Those of ordinary skill in the art can understand that all or part of the steps in the above methods can be completed by instructing relevant hardware through a program, and the program can be stored in a computer-readable storage medium, such as a read-only memory, a hard disk, or an optical disk. Optionally, all or part of the steps in the above embodiments can also be implemented using one or more integrated circuits. Correspondingly, each module unit in the above embodiments can be implemented in the form of hardware or a software functional module, and this application is not limited to any specific form of combination of software and hardware. The user equipment, terminal, and UE in this application include but are not limited to unmanned aerial vehicles (UAVs), communication modules on UAVs, remote-controlled aircraft, aircraft, small aircraft, mobile phones, tablet computers, laptops, on-board communication equipment, vehicles, Road Side Units (RSUs), wireless sensors, network cards, Internet of Things (IoT) terminals, Radio Frequency Identification (RFID) terminals, Narrow Band Internet of Things (NB-IoT) terminals, Machine Type Communication (MTC) terminals, enhanced MTC (eMTC) terminals, data cards, network cards, on-board communication equipment, low-cost mobile phones, low-cost tablet computers, and other wireless communication equipment. The base station or system equipment in this application includes but is not limited to macro cell base stations, micro cell base stations, small cell base stations, femtocells, relay base stations, evolved Node Bs (eNBs), gNBs, Transmitter Receiver Points (TRPs), Global Navigation Satellite Systems (GNSS), relay satellites, satellite base stations, aerial base stations, RSUs, UAVs, test equipment (such as transceivers simulating partial functions of base stations or signaling testers), and other wireless communication equipment.

Those skilled in the art should understand that the present invention can be implemented in other specific forms without departing from its core or basic characteristics. Therefore, the currently disclosed embodiments should be regarded as descriptive rather than restrictive in all respects. The scope of the invention is defined by the appended claims rather than the foregoing description, and all changes within the equivalent meaning and scope thereof are deemed to be included therein.

What is claimed is:

1. A first node for data collection in wireless communications, characterized by comprising:
a first receiver configured to receive a first information block, where the first information block indicates a process for a first RS resource;
wherein the process for the first RS resource set includes measuring on the first RS resource; the process for the first RS resource is for CSI reporting or for data collection; the process for the first RS resource is associated with a first priority value, the first priority value being linearly related to a first parameter, and the first parameter depends on whether the process for the first RS resource includes being for CSI reporting; when the process for the first RS resource is for CSI reporting, the first parameter is equal to 0; when the process for the first RS resource is for data collection, the first parameter is equal to 1.

2. The first node according to claim 1, wherein
the process for the first RS resource is for CSI reporting, the first priority value is equal to a first integer; the process for the first RS resource is for data collection, the first priority value is equal to a second integer; the first integer is a non-negative integer, the second integer is a positive integer, and the second integer is greater than the first integer.

3. The first node according to claim 1, wherein
the process for the first RS resource being for CSI reporting includes that the process for the first RS resource is for periodic CSI reporting.

4. The first node according to claim 2, wherein
the higher a priority value corresponding to a process, the lower a priority corresponding to the process;
or
a priority of a process for CSI reporting is higher than a priority of a process for data collection.

5. The first node according to claim 1, wherein
the measurement includes RSRP measurement.

6. A second node for data collection in wireless communications, characterized by comprising:
a first transmitter configured to transmit a first information block, where the first information block indicates a process for a first RS resource;
wherein the process for the first RS resource set includes a receiver of the first information block measuring on the first RS resource; the process for the first RS resource is for CSI reporting or for data collection; the process for the first RS resource is associated with a first priority value, the first priority value being linearly related to a first parameter, and the first parameter depends on whether the process for the first RS resource includes being for CSI reporting; when the process for the first RS resource is for CSI reporting, the first parameter is equal to 0; when the process for the first RS resource is for data collection, the first parameter is equal to 1.

7. The second node according to claim 6, wherein
the process for the first RS resource is for CSI reporting, the first priority value is equal to a first integer; the process for the first RS resource is for data collection, the first priority value is equal to a second integer; the first integer is a non-negative integer, the second integer is a positive integer, and the second integer is greater than the first integer.

8. The second node according to claim 6, wherein
the process for the first RS resource being for CSI reporting includes that the process for the first RS resource is for periodic CSI reporting.

9. The second node according to claim 7, wherein
the higher a priority value corresponding to a process, the lower a priority corresponding to the process;
or
a priority of a process for CSI reporting is higher than a priority of a process for data collection.

10. The second node according to claim 6, wherein
the measurement includes RSRP measurement.

11. A method in a first node for data collection in wireless communications, characterized by comprising:
receiving a first information block, where the first information block indicates a process for a first RS resource;
wherein the process for the first RS resource set includes measuring on the first RS resource; the process for the first RS resource is for CSI reporting or for data collection; the process for the first RS resource is associated with a first priority value, the first priority value being linearly related to a first parameter, and the first parameter depends on whether the process for the first RS resource includes being for CSI reporting; when the process for the first RS resource is for CSI reporting, the first parameter is equal to 0; when the process for the first RS resource is for data collection, the first parameter is equal to 1.

12. The method in the first node according to claim 11, wherein
the process for the first RS resource is for CSI reporting, the first priority value is equal to a first integer; the process for the first RS resource is for data collection, the first priority value is equal to a second integer; the first integer is a non-negative integer, the second integer is a positive integer, and the second integer is greater than the first integer.

13. The method in the first node according to claim 11, wherein
the process for the first RS resource being for CSI reporting includes that the process for the first RS resource is for periodic CSI reporting.

14. The method in the first node according to claim 12, wherein
the higher a priority value corresponding to a process, the lower a priority corresponding to the process;
or
a priority of a process for CSI reporting is higher than a priority of a process for data collection.

15. The method in the first node according to claim 11, wherein
the measurement includes RSRP measurement.

16. A method in a second node for data collection in wireless communications, characterized by comprising:
transmitting a first information block, where the first information block indicates a process for a first RS resource;
wherein the process for the first RS resource set includes a receiver of the first information block measuring on the first RS resource; the process for the first RS resource is for CSI reporting or for data collection; the process for the first RS resource is associated with a first priority value, the first priority value being linearly related to a first parameter, and the first parameter depends on whether the process for the first RS resource includes being for CSI reporting; when the process for the first RS resource is for CSI reporting, the first parameter is equal to 0; when the process for the first RS resource is for data collection, the first parameter is equal to 1.

17. The method in the second node according to claim 16, wherein
the process for the first RS resource is for CSI reporting, the first priority value is equal to a first integer; the process for the first RS resource is for data collection, the first priority value is equal to a second integer; the first integer is a non-negative integer, the second integer is a positive integer, and the second integer is greater than the first integer.

18. The method in the second node according to claim 16, wherein
the process for the first RS resource being for CSI reporting includes that the process for the first RS resource is for periodic CSI reporting.

19. The method in the second node according to claim 17, wherein
the higher a priority value corresponding to a process, the lower a priority corresponding to the process;
or
a priority of a process for CSI reporting is higher than a priority of a process for data collection.

20. The method in the second node according to claim 16, wherein
the measurement includes RSRP measurement.
